(19) United States
(12) Patent Application Publication
(10) Pub. No.: US 2024/0388655 A1
(43) Pub. Date: Nov. 21, 2024

(54) IN-CALL SCAM DETECTION

(71) Applicant: Google LLC, Mountain View, CA (US)

(72) Inventors: Lyubov Farafonova, San Francisco, CA (US); Yixuan Geng, Mountain View, CA (US); Usman Abdullah, Albany, CA (US); Rebecca Chiou, San Mateo, CA (US)

(21) Appl. No.: 18/662,999

(22) Filed: May 13, 2024

Related U.S. Application Data
(60) Provisional application No. 63/502,298, filed on May 15, 2023.

(51) Int. Cl. H04M 3/22

(52) U.S. Cl. CPC H04M 3/2281; H04M 3/2218

(57) ABSTRACT

A computing device may place or receive a call to establish the call with a caller. The computing device may determine whether a user of the computing device has configured the computing device to analyze call data from the call. While the call is ongoing, the computing device may analyze the call data from the call when the computing device has been configured to allow the analysis. The computing device may determine, based on contextual information associated with the call, whether the call satisfies a scam call threshold. Responsive to determining that the call satisfies the scam call threshold, the computing device may output an alert indicating the call with the caller is a scam call. The computing device may terminate the call with the caller in response to receiving user input to end the call.

### CROSS-REFERENCE TO RELATED APPLICATION

This application claims the benefit of U.S. Provisional Patent Application No. 63/502,298, filed 15 May 2023, the entire content of which is incorporated herein by reference.

### BACKGROUND

The widespread usage of mobile devices, such as smartphones, enables users to be able to place and receive calls at any place and at any time. As such, mobile devices have become a target by malicious actors to target potential victims through the use of scam calls. Phone calling scams are a pervasive problem world-wide. Victims of phone scams from the United States lost approximately $30 billion dollars (2022 estimate) with approximately 68.4 million US citizens reporting losing money to phone scams. Scam calls are not limited to only telephone calls. Recently, there has been an increase in scammers utilizing video calls and chat sessions in an attempt to scam victims.

Scammers either call users directly utilizing phone, video, or chat platforms or persuade users to call the scammers directly. Once a scammer has a potential victim on a call, the scammers can be extremely persuasive using false pretenses, and the scammers persuade victims to share money or personal information with them.

### SUMMARY

In general, the techniques of this disclosure are directed to techniques for enabling a mobile computing device to, after receiving explicit user permission, evaluate call data during phone calls, video calls, and chat sessions to determine whether the interaction is a scam call. For instance, analysis of call data may include analyzing audio data from phone calls, analyzing audio data, video data, and image data from video calls, and analyzing text data, image data, and audio data associated with attached audio clips from chat sessions. Analysis of call data may be performed on-the-fly, regardless of whether the computing device establishes a call with the caller by placing an outgoing call or receiving an incoming call.

The mobile computing device may process audio data associated with calls ephemerally, such that no call data or contextual information associated with the call is retained by the device or transmitted off-device. The mobile device may evaluate audio data of calls using artificial intelligence (AI) to determine whether an ongoing call is likely a scam interaction. For instance, the mobile device may utilize artificial intelligence, including the use of natural language processing (NLP), keyword matching, phrase matching, sentiment analysis, and on-device large language models (LLMs) to evaluate data from the phone call, video call, and chat session to determine whether the call is a likely scam interaction. User privacy settings may be configured to limit call data analysis to locally executing, on-device AI models. Use of on-device AI models may eliminate any need to retain call data on-device after the call concludes and eliminate any need to transmit information associated with the call off-device. In other examples, off-device AI models are utilized with user permission. For instance, call data may be transmitted off-device to a server for analysis. In certain cases, an AI model is trained off-device by servers of a cloud-based computing platform and a pre-trained AI model is downloaded to the mobile computing device for localized execution and localized on-device processing of call data.

In some instances, the mobile computing device may screen an incoming call, including potential scam and nuisance calls, without requiring the user of the computing device to manually answer the incoming call. The mobile computing device may answer the call without user input and conduct a natural language conversation with the calling party without user input to determine information related to the call. As the mobile computing device conducts screening of an incoming call, the mobile computing device may output a real-time transcript of the conversation with the calling party so that the user of the computing device may be able to follow along with the conversation.

In examples where incoming calls are screened prior to a user participating in the call, a caller clears the call screening, and the mobile computing device establishes a call with the remote computing device, the mobile computing device may evaluate call data from the call while connected with the remote computing device to determine if the call is a likely scam call. In the event the call is determined to satisfy a scam call threshold, the mobile computing device may initiate an alert to the mobile computing device indicating the call is a likely scam call and terminate the call responsive to a user request. A combination of screening techniques with call scam detection may help to reduce the number of scam calls actually received by users and when scam calls are received, reduce the likelihood of a user becoming a victim of scammers.

In one example, this disclosure describes a method that includes establishing, by one or more processors of a computing device, a call between the computing device and a caller. According to such an example, the one or more processors of the computing device may determine whether a user of the computing device configured the computing device to analyze call data from the call. Responsive to determining that the user configured the computing device to analyze the call data from the call and while the call is ongoing, the one or more processors of the computing device, may analyze the call data from the call and determine, based at least in part on contextual information associated with the call, whether the call satisfies a scam call threshold. According to at least one example, in response to determining that the call satisfies the scam call threshold, the one or more processors may output an alert indicating the call with the caller is a scam call. In response to receiving user input to end the call, the one or more processors may terminate the call with the caller.

In another example, this disclosure describes a computing device that includes a memory and one or more processors implemented in circuitry in communication with the memory. The one or more processors may be configured to establish a call between the computing device and a caller. According to such an example, the computing device may determine whether a user of the computing device configured the computing device to analyze call data from the call. Responsive to determining that the user configured the computing device to analyze the call data from the call and while the call is ongoing, the computing device may analyze the call data from the call and determine, based at least in part on contextual information associated with the call, whether the call satisfies a scam call threshold. According to at least one example, in response to determining that the call satisfies the scam call threshold, the computing device may output an alert indicating the call with the caller is a scam call. In response to receiving user input to end the call, the computing device may terminate the call with the caller.

In another example, this disclosure describes a non-transitory computer-readable storage medium encoded with instructions that, when executed by one or more processors, cause the one or more processors to establish a call between the computing device and a caller. According to such an example, the one or more processors may determine whether a user of the computing device configured the computing device to analyze call data from the call. Responsive to determining that the user configured the computing device to analyze the call data from the call and while the call is ongoing, the one or more processors may analyze the call data from the call and determine, based at least in part on contextual information associated with the call, whether the call satisfies a scam call threshold. According to at least one example, in response to determining that the call satisfies the scam call threshold, the one or more processors may output an alert indicating the call with the caller is a scam call. In response to receiving user input to end the call, the one or more processors may terminate the call with the caller.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIGS. 1A and 1B are conceptual diagrams illustrating an example environment for performing call screening with smart replies, in accordance with one or more aspects of the present disclosure.

FIG. 2 is a block diagram illustrating further details of an example computing device, in accordance with one or more aspects of the present disclosure.

FIGS. 3A and 3B illustrate techniques for call screening of incoming calls, in accordance with aspects of this disclosure.

FIG. 4 illustrates additional techniques for call screening, in accordance with aspects of this disclosure.

FIG. 5 is a flowchart illustrating an example technique for determining one or more candidate replies, in accordance with aspects of this disclosure.

FIG. 6 illustrates example candidate replies associated with use cases of a call, in accordance with aspects of this disclosure.

FIG. 7 is a flowchart illustrating example operations performed by an example computing device that is configured to perform call screening, in accordance with one or more aspects of the present disclosure.

FIG. 8 is a conceptual diagram illustrating a scam protection framework, in accordance with one or more aspects of the present disclosure.

FIG. 9 is a conceptual diagram illustrating an example GUI that includes user selectable options in responsive to a scam call alert, in accordance with one or more aspects of the present disclosure.

FIG. 10 is a conceptual diagram illustrating an example GUI that includes various user selectable options based on a determination by scam protection framework that a call is a scam call, in accordance with one or more aspects of the present disclosure.

FIG. 11 is a conceptual diagram illustrating an example GUI that includes various user selectable options to provide feedback based on a determination by a scam protection framework that a call is a scam call, in accordance with one or more aspects of the present disclosure.

FIG. 12 is a conceptual diagram illustrating an example GUI that includes various user selectable options to provide feedback based on a determination by a scam protection framework that a call is a scam call, in accordance with one or more aspects of the present disclosure.

FIG. 13 is a flowchart illustrating example operations performed by an example computing device that is configured to detect and alert for scam calls, in accordance with one or more aspects of the present disclosure.

### DETAILED DESCRIPTION

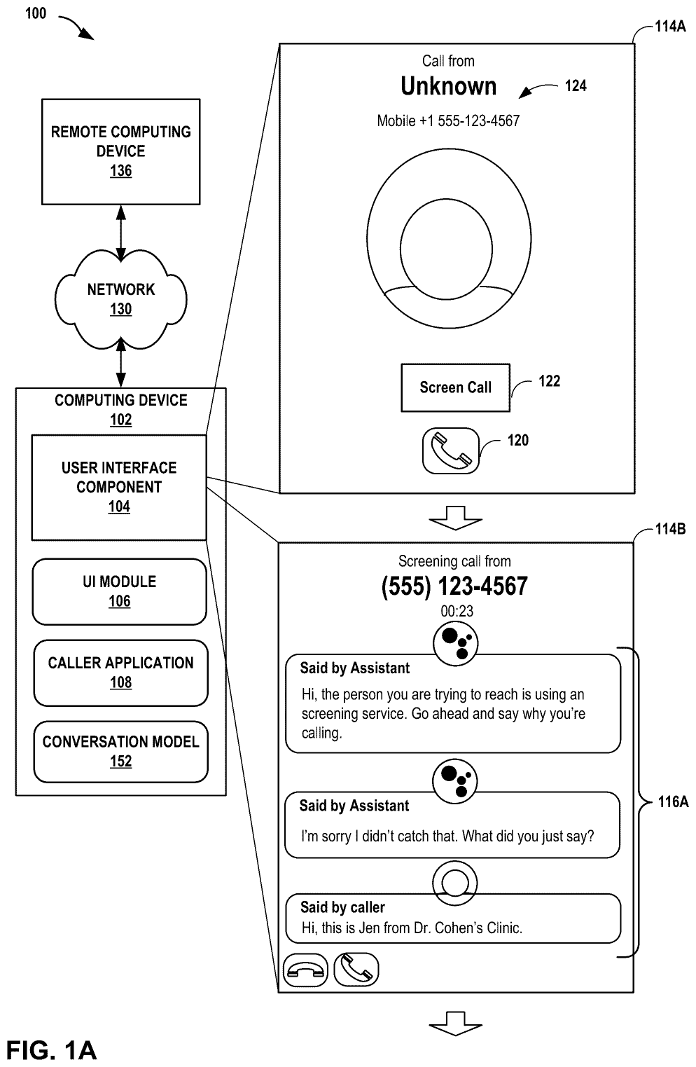

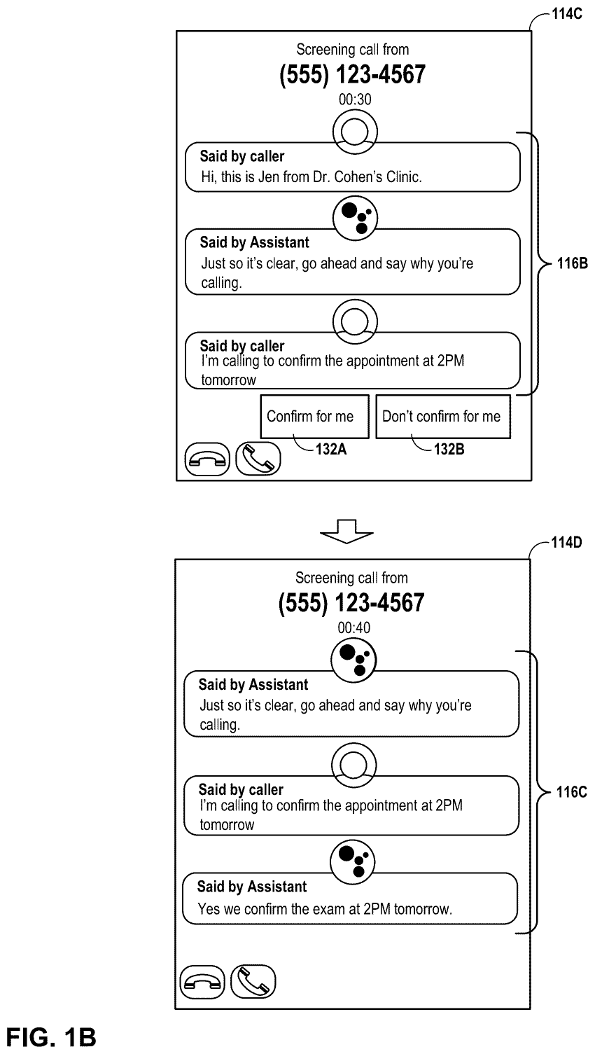

FIGS. 1A and 1B are conceptual diagrams illustrating an example environment for performing call screening with smart replies, in accordance with one or more aspects of the present disclosure. In the example of FIGS. 1A and 1B, environment 100 may include computing device 102 that connects to network 130 to place and receive calls to and more remote communication devices, such as remote computing device 136.

As shown in FIG. 1A, computing device 102 may represent an individual mobile or non-mobile computing device. Examples of computing device 102 include a mobile phone, a tablet computer, a laptop computer, a desktop computer, a server, a mainframe, a set-top box, a television, a wearable device (e.g., a computerized watch, computerized eyewear, computerized headphones, computerized gloves, etc.), a home automation device or system (e.g., an intelligent thermostat or home assistant device), a personal digital assistant (PDA), a gaming system, a media player, an e-book reader, a mobile television platform, an automobile navigation or infotainment system, or any other type of mobile, non-mobile, wearable, and non-wearable computing device.

Computing device 102 may connect to network 130 to place and receive calls to and from remote computing devices, such as remote computing device 136. Network 130 represents public or private communications network, such as Wi-Fi, one or more wireless wide area networks (e.g., a wireless cellular network, a satellite network, and/or a Free-Space Optical Communication network), one or more telephony network, such as one or more Public Switched Telephone Networks (PTSNs), one or more VOIP services, and/or other types of networks, for transmitting data between computing systems, servers, and computing devices, such as over the Internet. Network 130 may include one or more network hubs, network switches, network routers, or any other network equipment, that are operatively inter-coupled thereby providing for the exchange of information between computing device 102 and remote computing devices, such as remote computing device 136. Computing device 102 and remote computing devices, such as remote computing device 136 may transmit and receive data across network 130 using any suitable communication techniques. Computing device 102 may be operatively coupled to network 130 using respective network links, such as Ethernet, Wi-Fi, a cellular connection, or any other types of wired and/or wireless network connections.

Network 130 may implement any suitable technology and may include any suitable networks that enable computing device 102 to place and receive calls to and from remote computing devices. In some examples, network 130 may implement an IP Multimedia Subsystem (IMS) that manages call sessions, including call routing, authentication and billing. The IMS may also act as a Session Initiation Protocol (SIP) server that uses SIP to perform call setup and teardown functions and to perform signaling and messaging protocols used for calls between computing devices. In some examples, network 130 may implement the functionality of an Evolved Packet (EPG) core or a System Architecture Evolution (SAE) core to handle communication between devices connected to network 130 and to networks external to network 130.

Remote computing device 136 represents a device that is connected to network 130 to make and receive calls, such as voice calls and/or video calls. Examples of remote computing device 136 include a landline telephone, a mobile phone, a tablet computer, a laptop computer, a desktop computer, a satellite phone, or any other type of device that can communicate with network 130.

Computing device 102 includes user interface component (UIC) 104, user interface module 106 (“UI module 106”), caller application 108, and conversation model 152. UIC 104 of computing device 102 may function as an input device for computing device 102 and as an output device for computing device 102. UIC 104 may be implemented using various technologies. For instance, UIC 104 may function as an input device using a presence-sensitive input screen, such as a resistive touchscreen, a surface acoustic wave touchscreen, a capacitive touchscreen, a projective capacitive touchscreen, a pressure sensitive screen, an acoustic pulse recognition touchscreen, or another presence-sensitive display technology, such as radar-based presence-sensitive technology millimeter wave-based presence-sensitive technology, ultra-wideband-based presence-sensitive technology, and the like. In some examples, UIC 104 may function as an input device using one or more audio input devices, such as one or more microphones. UIC 104 may function as an output (e.g., display) device using any one or more display devices, such as a liquid crystal display (LCD), dot matrix display, light emitting diode (LED) display, microLED, organic light-emitting diode (OLED) display, e-ink, or similar monochrome or color display capable of outputting visible information to a user of computing device 102. In some examples, UIC 104 may function as an audio output device and may include one or more speakers, one or more headsets, or any other audio output device capable of outputting audible information to a user of computing device 102.

In some examples, UIC 104 of computing device 102 may include a presence-sensitive display that may receive tactile input from a user of computing device 102. UIC 104 may receive indications of the tactile input by detecting one or more gestures from a user of computing device 102 (e.g., the user touching or pointing to one or more locations of UIC 104 with a finger or a stylus pen). UIC 104 may present output to a user, for instance at a presence-sensitive display. UIC 104 may present the output as a graphical user interface (e.g., graphical user interfaces 114A-114D), which may be associated with functionality provided by computing device 102. For example, UIC 104 may present various user interfaces of components of a computing platform, operating system, applications (e.g., caller application 108), or services executing at or accessible by computing device 102 (e.g., an electronic message application, an Internet browser application, a mobile operating system, etc.). A user may interact with a respective user interface to cause computing device 102 to perform operations relating to a function.

UI module 106, caller application 108, and conversation model 152 may perform operations described herein using software, hardware, firmware, or a mixture of both hardware, software, and firmware residing in and executing on computing device 102 or at one or more other remote computing devices. In some examples, UI module 106, caller application 108, and conversation model 152 may be implemented as hardware, software, and/or a combination of hardware and software. Computing device 102 may execute UI module 106, caller application 108, and conversation model 152 with one or more processors. Computing device 102 may execute any of UI module 106, caller application 108, and conversation model 152 as or within a virtual machine executing on underlying hardware. UI module 106 and caller application 108 may be implemented in various ways. For example, any of UI module 106, caller application 108, and conversation model 152 may be implemented as a downloadable or pre-installed application or “app.” In another example, any of UI module 106, caller application 108, and conversation model 152 may be implemented as part of an operating system of computing device 102. Other examples of computing device 102 that implement techniques of this disclosure may include additional components not shown in FIG. 1A.

In the example of FIG. 1A, conversation model 152 may include a hardware device having various hardware, firmware, and software components. However, FIG. 1A illustrates only one particular example of conversation model 152, and many other examples of conversation model 152 may be used in accordance with techniques of this disclosure. In some examples, components of conversation model 152 may be located in a singular location. In other examples, one or more components of conversation model 152 may be in different locations (e.g., connected via network 130). That is, in some examples conversation model 152 may be part of a conventional computing device, while in other examples, conversation model 152 may be part of a distributed or “cloud” computing system. Further, conversation model 152 may be located in and executed by a computing system remote from and communicatively coupled to computing device 102. In such examples, computing device 102 may send and receive messages, data, or otherwise exchange information with the remote computing system such that the remote computing system provides computing device 102 with the functionality of conversation model 152. In some examples, conversation model 152 may be functionally split between computing device 102 and one or more remote computing systems such that a portion of the functionality provided by conversation model 152 is performed locally at computing device 102 and other portions of the functionality are performed by the one or more remote computing systems.

UI module 106 may interpret inputs detected at UIC 104. UI module 106 may relay information about the inputs detected at UIC 104 to one or more associated platforms, operating systems, applications, and/or services executing at computing device 102 to cause computing device 102 to perform a function. UI module 106 may also receive information and instructions from one or more associated platforms, operating systems, applications, and/or services executing at computing device 102 (e.g., caller application 108) for generating a GUI. In addition, UI module 106 may act as an intermediary between the one or more associated platforms, operating systems, applications, and/or services executing at computing device 102 and various output devices of computing device 102 (e.g., speakers, LED indicators, vibrators, etc.) to produce output (e.g., graphical, audible, tactile, etc.) with computing device 102.

Caller application 108 may include functionality for placing and receiving calls via network 130 to and from remote computing devices such as remote computing device 136. Examples of caller application 108 may include a phone dialer application, a Voice over IP (VOIP) application, a messaging application with voice calling functionality, a video conferencing application, a video calling application, or any other application that includes functionality for placing and receiving calls.

In the example of FIG. 1A, applications 112 may send data to UI module 106 that causes UIC 104 to generate user interfaces (GUIs), such as GUIs 114A-114D (collectively “GUIs 114”) and elements thereof. In response, UI module 106 may output instructions and information to UIC 104 that cause UIC 104 to display a user interface (e.g., GUI 114A) according to the information received from the application. When handling input detected by UIC 104, UI module 106 may receive information from UIC 104 in response to inputs detected at locations of a screen of UIC 104 at which elements of the user interface are displayed. UI module 106 disseminates information about inputs detected by UIC 104 to other components of computing device 102 for interpreting the inputs and for causing computing device 102 to perform one or more functions in response to the inputs.

In accordance with aspects of this disclosure, computing device 102 may establish a call with remote computing device 136, such as by placing a call to remote computing device 136 via network 130 or receiving a call from remote computing device 136 via network 130. Examples of calls placed and received by computing device 102 may include a voice call such as a telephone call or a Voice over Internet Protocol (VOIP) call, a video call such as a videoconferencing call, a real-time mixed reality session, a real-time augmented reality session, a media call, a text messaging session, a chat-bot session, or any other calls between two or more devices. Once computing device 102 has established the call with remote computing device 136, computing device 102 and remote computing device 136 may be able to exchange audio data. Computing device 102 may send, to remote computing device 136 during the call, audio data such as spoken words and phrases. Similarly, computing device 102 may receive, from remote computing device 136 during the call, audio data such as words and phrases spoken by a user of remote computing device 136.

Computing device 102 may, in response to receiving an incoming call, determine whether to alert the user of computing device 102 to the incoming call, such as by determining whether to ring (e.g., audibly outputting a ringtone and/or outputting a haptic pattern) to alert the user of computing device 102 to the incoming call. Computing device 102 may determine whether to alert the user of computing device 102 to the incoming call based at least in part on determining whether the incoming call is a spam call. Computing device 102 may determine whether the incoming call is a spam call using any suitable spam detection technique, such as by determining whether the phone number associated with the incoming call is on a list of known spam callers, whether the user of computing device 102 had previously marked the phone number associated with the incoming call as a spam caller, and the like. If computing device 102 determines that the incoming call is a spam call, computing device 102 may reject the call and/or may send the incoming call to voicemail without alerting the user to the incoming call.

In some examples, computing device 102 may determine whether to alert the user of computing device 102 to the incoming call based at least in part on whether the user is available to take the call. Computing device 102 may determine whether the user is available to take the call based on contextual information such as whether the do not disturb feature of computing device 102 is turned on, the schedule of the user as stored in the calendar of computing device 102 (e.g., whether the user is currently in a meeting as scheduled in the calendar), the current time and/or date, the current location of computing device 102, the current state of the user (e.g., if the user is currently driving or if the user is currently sleeping), and the like.

If computing device 102 determines that the user of computing device 102 is not available to take the incoming call, computing device 102 may send the incoming call to voicemail without alerting the user to the incoming call. In some examples, computing device 102 may execute caller application 108 to perform automatic call screening of an incoming call to gather certain information from the party calling from remote computing device 136, such as the identity of the party (e.g., the name of the caller and/or the identity of the entity that is calling), the purpose of the call, and/or any other relevant information. As described below, computing device 102 may perform call screening to conduct a natural language conversation with the caller associated with remote computing device 136 and may store a transcript of the conversation and a recording of the conversation for later review by the user of computing device 102.

In the example of FIG. 1A, if computing device 102 determines to alert the user of computing device 102 to an incoming call, computing device 102 may, in response to receiving an incoming call from remote computing device 136, execute caller application 108 to send data to UI module 106 that causes UIC 104 to display GUI 114A to alert the user of computing device 102 to the incoming call. For example, UIC 104 may display GUI 114A while ringing (e.g., audibly outputting a ringtone and/or outputting a haptic pattern) to alert the user of computing device 102 to the incoming call.

GUI 114A may include call information 124 associated with the incoming call, such as the phone number from which the incoming call originated, the name of the person or entity associated with the phone number or whether the name of the person or entity associated with the phone number is unknown, and the like. GUI 114A may include call answering UI element 120 that the user may select (e.g., by providing user input at UIC 104) to answer the call.

GUI 114A may also include call screen UI element 122 that a user may select (e.g., by providing user input at UIC 104) to cause computing device 102 to perform call screening of the incoming call. Computing device 102 may execute caller application 108 to perform call screening of an incoming call to gather certain information from the party calling from remote computing device 136, such as the identity of the party (e.g., the name of the caller and/or the identity of the entity that is calling), the purpose of the call, and/or any other relevant information.

Computing device 102 may perform call screening of an incoming call without the user of computing device 102 having to answer the call and without the user of computing device 102 having to converse with the party calling from remote computing device 136. Rather, caller application 108 may perform call screening of an incoming call by answering the call to establish the call between computing device 102 and remote computing device 136 and by conducting a natural language conversation with the party calling from remote computing device 136 using a human-like voice with human-like vocal characteristics. That is, caller application 108 may receive, from remote computing device 136, utterances, such as words, phrases and sentences spoken by a user of remote computing device 136, and to generate natural language utterances, such as spoken words, phrases and sentences, that are sent to remote computing device 136, such as by audibly outputting the natural language utterances in the call.

Caller application 108 may be able to conduct the natural language conversation with remote computing device 136 to gather certain information from the party calling from remote computing device 136, such as the identity of the party (e.g., the name of the caller and/or the identity of the entity that is calling), the purpose of the call. Caller application 108 may be able to record the audio of the call and save a transcript of the call at computing device 102 so that the user of computing device 102 may be able to listen to a recording of the call and/or read the transcript of the call at a later time.

Caller application 108 may be able to conduct the natural language conversation with remote computing device 136 without user interactions. That is, caller application 108 is able to generate utterances and to send such utterances to remote computing device 136 in the call without user interaction. For example, caller application 108 may, in response to receiving an utterance from remote computing device 136, determine an appropriate response to the utterance without user input that indicates how caller application 108 should respond to the received utterance. In this way caller application 108 may be able to conduct a multi-turn natural language conversation with remote computing device 136.

As caller application 108 performs call screening of the call, caller application 108 may refrain from outputting audio of the natural language conversation being conducted with remote computing device 136. Caller application 108 may also refrain from transmitting, to remote computing device 136, any audio that may be captured by audio input devices (e.g., microphones) of UIC 104 and/or may disable such audio input devices of UIC 104. Rather, to enable the user of computing device 102 to follow along with the natural language conversation being conducted between computing device 102 and remote computing device 136, caller application 108 may, as caller application 108 performs call screening of the call received from remote computing device 136 by conducting the natural language conversation in the call with remote computing device 136, output a real-time text transcript of the natural language conversation taking place during the call.

As shown in FIG. 1A, caller application 108 may, as part of performing call screening of an incoming call from remote computing device 136, send data to UI module 106 that causes UIC 104 to display GUI 114B that includes a real-time transcript 116A of the conversation taking place in the call between computing device 102 and remote computing device 136. As can be seen in the real-time transcript 116A of the conversation, caller application 108 may start off the conversation by greeting the party using remote computing device 136 and by asking for the purpose of the call (e.g., “Go ahead and say why you're calling”).

Caller application 108 may, while conducting the conversation, detect a prolonged silence during the call, such as by determining that caller application 108 has not received an utterance from remote computing device 136 for a certain amount of time (e.g., 5 seconds, 10 seconds, etc.). Caller application 108 may, in response to detecting the prolonged silence, prompt the calling party to speak (e.g., “I'm sorry I didn't catch that. What did you say?”). Caller application 108 may conduct the conversation to gather information regarding the call, such as the name of the caller and the purpose of the call. As such, if caller application 108 determines, based on the conversation that has been conducted, that the calling party has identified themselves but has not stated their purpose for the call, caller application 108 may ask for the purpose of the call (e.g., “go ahead and say why you're calling”).

Caller application 108 may use conversation model 152 to determine one or more words, one or more phrases, one or more sentences, and the like that is to be spoken as part of the conversation and to generate utterances of such words, phrases, and sentences as part of the conversation. Conversation model 152 may include one or more neural networks, such as a generative adversarial network (GAN), a recurrent neural network (RNN), and the like that is trained via machine learning on a corpus of anonymized phone conversation data to determine a reply to utterances received from remote computing device 136.

For example, caller application 108 may, in response to receiving an utterance in the call from remote computing device 136, use automatic speech recognition to convert the utterance into text and may input the converted text into conversation model 152 along with any other relevant contextual information such as previous utterances in the conversation during the call (e.g., words, phrases, and/or sentences previously spoken by the parties on the call), the vocal characteristics (e.g., intonation) of utterances received from remote computing device 136, whether the identity of the remote computing device 136 is listed in the contacts of computing device 102, the location of computing device 102 and/or remote computing device 136, the current time and/or date, events listed in an calendar application of computing device 102, previous conversations with the party using remote computing device 136, or any other relevant contextual information. Conversation model 152 may determine, based on the inputted data, one or more words, phrases, and/or words that caller application 108 may convert (e.g., via text-to-speech) to an utterance that caller application 108 may send as part of the conversation to remote computing device 136.

In accordance with aspects of this disclosure, as computing device 102 conducts the conversation with remote computing device 136, caller application 108 may determine one or more candidate replies that are relevant to the conversation. Caller application 108 may output indications of the one or more candidate replies for display at UIC 104 to enable the user of computing device 102 to select a candidate reply. Caller application 108 may generate and send a reply in the conversation that corresponds to the selected candidate reply.

Caller application 108 may determine one or more candidate replies that are relevant to the conversation. In the case of a conversation, relevant replies to the conversation may be replies that are relevant to replying to the utterance that was most recently received from remote computing device 136 as part of the conversation and/or replies that are highly likely or probable to be selected by the user to respond to the utterance that was most recently received from remote computing device 136 as part of the conversation.

Caller application 108 may determine the one or more candidate replies based on contextual information, such as contextual information associated with the call. Such contextual information may include previous utterances in the conversation during the call (e.g., words, phrases, and/or sentences previously spoken by the parties on the call), the vocal characteristics (e.g., intonation) of utterances received from remote computing device 136, whether the identity of the remote computing device 136 is listed in the contacts of computing device 102, whether the caller is from a business or other entity, the location of computing device 102 and/or remote computing device 136, the current time and/or date, events listed in an calendar application of computing device 102, previous conversations with the party using remote computing device 136, a use case of the call, or any other relevant contextual information.

Caller application 108 may use conversation model 152 to determine one or more candidate replies. For example, caller application 108 may, in response to receiving an utterance in the call from remote computing device 136, input the contextual information into conversation model 152 to determine, based on the inputted data, one or more candidate replies that are relevant to the conversation.

Caller application 108 may output an indication of each of the one or more candidate replies, such as for display at UIC 104, so that a user may interact with UIC 104 to select a candidate reply out of the one or more candidate replies. In the example of FIGS. 1A and 1B, as computing device 102 continues to conduct the conversation with remote computing device 136, caller application 108 may send data to UI module 106 that causes UIC 104 to display GUI 114C that includes UI elements 132A and 132B that each corresponds to a candidate reply determined by computing device 102.

GUI 114C also includes an updated real-time transcript 116B of the conversation. taking place in the call between computing device 102 and remote computing device 136. As shown in the updated real-time transcript 116B of the conversation, the party at remote computing device 136 is calling to confirm a doctor's appointment for 2 PM tomorrow. Caller application 108 may determine one or more candidate replies that are relevant to the conversation, such as by determining that the party at remote computing device 136 is calling to confirm a doctor's appointment for 2 PM tomorrow. Caller application 108 may therefore determine one or more candidate replies to reply to the request to confirm the appointment, such as a candidate reply confirming the appointment and a candidate reply to not confirm the appointment, and caller application 108 may cause GUI 114C to include UI element 132A that corresponds to the candidate reply confirming the appointment and UI element 132B that correspond to the candidate reply to not confirm the appointment.

Computing device 102 may receive, from UIC 104, an indication of a user input that selects a candidate reply from the one or more candidate replies and may, in response, send a reply in the conversation that corresponds to the selected candidate reply. For example, if the user interacts with UIC 104 to select UI element 132A, UI module 106 may receive, from UIC 104, an indication of user input that selects UI element 132, and caller application 108 may receive, from UI module 106, an indication that the user has selected UI element 132 corresponding to the candidate reply confirming the appointment.

Caller application 108 may not necessarily send a reply that is word-for-word the same as the candidate reply. Instead, caller application 108 may generate a reply (e.g., one or more words, phrases, and/or sentences) having the same or similar meaning to the selected candidate reply, and may send, as part of the conversation, a spoken version of the reply to remote computing device 136.

As shown in FIG. 1B, in response to the user interacting with UIC 104 to select UI element 132A that corresponds to the candidate reply confirming the appointment, caller application 108 may generate a reply confirming the appointment and may send, as part of the conversation, the reply to remote computing device 136. Caller application 108 may send data to UI module 106 that causes UIC 104 to display GUI 114D that includes an updated real-time transcript 116C of the conversation. As can be seen in the updated real-time transcript 116C of the conversation, caller application 108 may generate a reply of “Yes we confirm the appointment for 2 PM tomorrow” and may send the reply as part of the conversation to remote computing device 136.

As caller application 108 continues to perform call screening of the call and conducts the conversation with remote computing device 136, caller application 108 may continue to update the candidate replies that are outputted for display by UIC 104. That is, the candidate replies determined by caller application 108 does not remain static during the call screening process, but may adaptively change depending on the context of the call and/or the conversation, thereby enabling the user to select candidate replies that are relevant to the current context of the call.

While the call screening techniques described in FIGS. 1A and 1B relate to call screening of incoming calls, the call screening techniques described herein may also be applied to outgoing calls. For example, the user of computing device 102 may direct caller application 108 to place an outgoing call to perform a task, such as to book a restaurant reservation. Caller application 108 may be able to place such a call and conduct a natural language conversation, such as described above, during the call, in order to accomplish the task.

The techniques of this disclosure enables a computing device to reduce the amount of user interaction required to answer calls such as telephone calls, video calls, and chat sessions. By performing call screening of incoming calls and conducting a natural language conversation with the calling party, the techniques of disclosure may not require the user of a computing device to have to speak in the call or to listen to the call. Furthermore, by determining candidate replies to the conversation that are relevant to the conversation and by enabling the user to select a candidate reply to reply to the conversation taking place, the techniques of this disclosure may enable the user to reply to questions or queries received in the call without having to speak in the call or to listen to the call.

Being able to conduct a natural language conversation with the calling party and enabling the user to reply to questions or queries received in the call without requiring the user to have to speak or listen to the call may enable people with disabilities, such as people with social anxiety or people with hearing and/or speech disabilities, or people who do not enjoy speaking on the phone, to be able to use the computing device to answer incoming calls without needing additional specialized devices and/or services, such as a speech to speech relay service. Being able to conduct a natural language conversation with the calling party and enabling the user to reply to questions or queries received in the call without requiring the user to have to speak or listen to the call may also prevent malicious parties from learning what the user's voice sounds like and may prevent malicious parties from potentially capturing the user's voice and using the user's voice for malicious purposes.

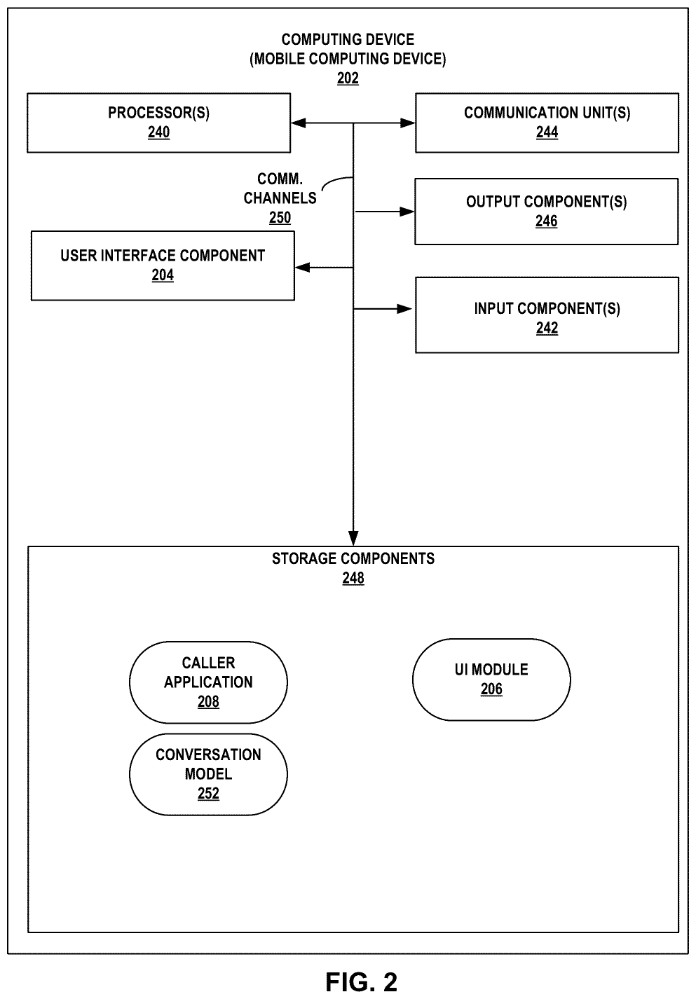

FIG. 2 is a block diagram illustrating further details of an example computing device, in accordance with one or more aspects of the present disclosure. Computing device 202 of FIG. 2 is described below as an example of computing device 102 as illustrated in FIGS. 1A and 1B.

Computing device 202 of FIG. 2 may be an example of a mobile phone, a tablet computer, a laptop computer, a desktop computer, a server, a mainframe, a set-top box, a television, a wearable device, a home automation device or system, a gaming system, a media player, an e-book reader, a mobile television platform, an automobile navigation or infotainment system, or any other type of mobile, non-mobile, wearable, and non-wearable computing device configured to communicate with a network, such as network 130 as illustrated in FIGS. 1A and 1B. FIG. 2 illustrates only one particular example of computing device 202, and many other examples of computing device 202 may be used in other instances and may include a subset of the components included in example computing device 202 or may include additional components not shown in FIG. 2.

As shown in the example of FIG. 2, computing device 202 includes user interface component (UIC) 204, one or more processors 240, one or more input components 242, one or more communication units 244, one or more output components 246, and one or more storage components 248. Storage components 248 of computing device 202 also include user interface (UI) module 206, caller application 208, and conversation model 252. UI module 206 is an example of UI module 106 of FIGS. 1A and 1B, and caller application 208 is an example of caller application 108 of FIGS. 1A and 1B. Conversation model 252 is an example of conversation model 152 of FIGS. 1A and 1B.

Communication channels 250 may interconnect each of the components 240, 204, 244, 246, 242, and 248 for inter-component communications (physically, communicatively, and/or operatively). In some examples, communication channels 250 may include a system bus, a network connection, an inter-process communication data structure, or any other method for communicating data.

One or more input components 242 of computing device 202 may receive input. Examples of input are tactile, audio, and video input. One or more input components 242 of computing device 202, in one example, includes a presence-sensitive display, touch-sensitive screen, mouse, keyboard, voice responsive system, video camera, microphone or any other type of device for detecting input from a human or machine.

One or more output components 246 of computing device 202 may generate output. Examples of output are tactile, audio, and video output. One or more output components 246 of computing device 202, in one example, includes a presence-sensitive display, sound card, video graphics adapter card, speaker, liquid crystal display (LCD), light-emitting diode (LED) display, miniLED, microLED, organic light-emitting diode (OLED) display, a light field display, haptic motors, linear actuating devices, or any other type of device for generating output to a human or machine.

One or more communication units 244 of computing device 202 may communicate with external devices via one or more wired and/or wireless networks by transmitting and/or receiving network signals on the one or more networks. Examples of one or more communication units 244 include a network interface card (e.g., an Ethernet card), an optical transceiver, a radio frequency transceiver, a GPS receiver, or any other type of device that can send and/or receive information. Other examples of one or more communication units 244 may include short wave radios, cellular data radios, wireless network radios, as well as universal serial bus (USB) controllers.

UIC 204 of computing device 202 may be hardware that functions as an input and/or output device for computing device 202. For example, UIC 204 may include a display component, which may be a screen at which information is displayed by UIC 204 and a presence-sensitive input component that may detect an object at and/or near the display component.

One or more processors 240 may implement functionality and/or execute instructions within computing device 202. For example, one or more processors 240 on computing device 202 may receive and execute instructions stored by storage components 248 that execute the functionality of UI module 206, caller application 208, and conversation model 252. The instructions executed by one or more processors 240 may cause computing device 202 to store information within storage components 248 during program execution. Examples of one or more processors 240 include application processors, display controllers, sensor hubs, and any other hardware configured to function as a processing unit. One or more processors 240 may execute instructions of UI module 206, caller application 208, and conversation model 252 to perform actions or functions. That is, UI module 206, caller application 208, and conversation model 252 may be operable by one or more processors 240 to perform various actions or functions of computing device 202.

One or more storage components 248 within computing device 202 may store information for processing during operation of computing device 202. That is, computing device 202 may store data accessed by UI module 206, caller application 208, and conversation model 252 during execution at computing device 202. In some examples, storage component 248 is a temporary memory, meaning that a primary purpose of storage component 248 is not long-term storage. Storage components 248 on computing device 202 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 may be configured to store larger amounts of information than volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with UI module 206, caller application 208, and conversation model 252.

One or more processors 240 are configured to execute UI module 206, caller application 208, and conversation model 252 to perform any combination of the techniques described in this disclosure. For example, one or more processors 240 are configured to execute caller application 208 to receive an incoming call from a remote computing device (e.g., remote computing device 136 of FIG. 1A) and to determine whether to alert the user of computing device 202 to the incoming call, such as by determining whether to ring (e.g., audibly outputting a ringtone and/or outputting a haptic pattern) to alert the user of computing device 202 to the incoming call. One or more processors 240 are configured to execute caller application 208 to determine whether to alert the user of computing device 202 to the incoming call based at least in part on determining whether the incoming call is a spam call. One or more processors 240 are configured to execute caller application 208 to determine whether the incoming call is a spam call using any suitable spam detection technique, such as by determining whether the phone number associated with the incoming call is on a list of known spam callers, whether the user of computing device 202 had previously marked the phone number associated with the incoming call as a spam caller, and the like. If computing device 202 determines that the incoming call is a spam call, one or more processors 240 are configured to execute caller application 208 to reject the call and/or may send the incoming call to voicemail without alerting the user to the incoming call.

In some examples, one or more processors 240 are configured to execute caller application 208 to determine whether to alert the user of computing device 202 to the incoming call based at least in part on whether the user is available to take the call. One or more processors 240 are configured to execute caller application 208 to determine whether the user is available to take the call based on contextual information such as whether the do not disturb feature of computing device 202 is turned on, the schedule of the user as stored in the calendar of computing device 202 (e.g., whether the user is currently in a meeting as scheduled in the calendar), the current time and/or date, the current location of computing device 202, the current state of the user (e.g., if the user is currently driving or if the user is currently sleeping), and the like.

If caller application 208 determines that the user of computing device 202 is not available to take the incoming call, one or more processors 240 are configured to execute caller application 208 to send the incoming call to voicemail without alerting the user to the incoming call. In some examples, one or more processors 240 are configured to execute caller application 208 to perform automatic call screening of an incoming call to gather certain information from the party calling from the remote computing device, such as the identity of the party (e.g., the name of the caller and/or the identity of the entity that is calling), the purpose of the call, and/or any other relevant information. As described throughout this disclosure, one or more processors 240 are configured to execute caller application 208 to perform call screening to conduct a natural language conversation with the caller associated with the remote computing device and may store a transcript of the conversation and a recording of the conversation for later review by the user of computing device 202.

If caller application 208 determines to alert the user of computing device 202 to an incoming call, one or more processors 240 are to ring computing device 202 (e.g., audibly outputting a ringtone and/or outputting a haptic pattern) to alert the user of computing device 202 to the incoming call and to enable the user to direct computing device 202 to perform call screening of the incoming call. If the user of computing device 202 directs computing device 202 to perform call screening of the incoming call, such as by interacting with UIC 204 to provide user input that corresponds to selection of call screening user interface element, one or more processors 240 are configured to execute caller application 208 to perform call screening of the incoming call.

One or more processors 240 are configured to execute caller application 208 to perform call screening of an incoming call to gather certain information from the party calling from the remote computing device, such as the identity of the party (e.g., the name of the caller and/or the identity of the entity that is calling), the purpose of the call, and/or any other relevant information. Caller application 208 may perform call screening of an incoming call without the user of computing device 202 having to answer the call and without the user of computing device 202 having to converse with the party calling from the remote computing device. Rather, one or more processors 240 are configured to execute caller application 208 to perform call screening of an incoming call by answering the call to establish the call between computing device 202 and the remote computing device and by conducting a natural language conversation with the party calling from the remote computing device. That is, caller application 208 is able to receive, from the remote computing device, utterances, such as words, phrases and sentences spoken by a user of the remote computing device, and to generate natural language utterances, such as spoken words, phrases and sentences, that are sent to the remote computing device.

Caller application 208 may be able to conduct the natural language conversation with the remote computing device to gather certain information from the party calling from the remote computing device, such as the identity of the party (e.g., the name of the caller and/or the identity of the entity that is calling), the purpose of the call. Caller application 208 may be able to record the audio of the call and save a transcript of the call at computing device 202 so that the user of computing device 202 may be able to listen to a recording of the call and/or read the transcript of the call at a later time.

Caller application 208 may be able to conduct the natural language conversation with the calling party of the remote computing device without user interactions. That is, caller application 108 is able to generate utterances and to send such utterances to the remote computing device in the call without user interaction. For example, one or more processors 240 are configured to execute caller application 208 to, in response to receiving an utterance from the remote computing device, determine an appropriate response to the utterance without user input that indicates how caller application 208 should respond to the received utterance. In this way caller application 208 may be able to conduct a multi-turn natural language conversation with the calling party at the remote computing device.

As caller application 208 performs call screening of the call, one or more processors 240 are configured to execute caller application 208 to refrain from outputting audio of the natural language conversation being conducted with the remote computing device. One or more processors 240 are configured to execute caller application 208 to also refrain from transmitting, to the remote computing device, any audio that may be captured by audio input devices (e.g., microphones) of UIC 204 and/or may disable such audio input devices of UIC 204. Rather, to enable the user of computing device 202 to follow along with the natural language conversation being conducted between computing device 202 and the remote computing device 136, one or more processors 240 are configured to execute caller application 208 to output, for display at UIC 204, a real-time text transcript of the natural language conversation taking place during the call. For example, one or more processors 240 are configured to execute caller application 208 to perform a speech-to-text transcription of the call to generate the real-time transcript of the conversation taking place during the call.

One or more processors 240 are configured to execute caller application 208 to conduct the conversation to gather information regarding the call, such as the name of the caller and the purpose of the call. Caller application 208 may use conversation model 252 to determine one or more words, one or more phrases, one or more sentences, and the like that is to be spoken as part of the conversation and to generate utterances of such words, phrases, and sentences as part of the conversation. Conversation model 252 may include one or more neural networks, such as a generative adversarial network (GAN), a recurrent neural network (RNN), and the like that is trained via machine learning on a corpus of anonymized phone conversation data to determine a reply to utterances received by caller application 208 during the call.

For example, one or more processors 240 are configured to execute caller application 208 to, in response to receiving an utterance in the call, perform automatic speech recognition to convert the utterance into text and to input the converted text into conversation model 252 along with any other relevant contextual information, such as previous utterances in the conversation during the call (e.g., words, phrases, and/or sentences previously spoken by the parties on the call), the vocal characteristics (e.g., intonation) of utterances received in the call, whether the identity of the remote computing device is listed in the contacts of computing device 202, the location of computing device 202 and/or the remote computing device, the current time and/or date, events listed in an calendar application of computing device 202, previous conversations with the party using the computing device, or any other relevant contextual information. One or more processors 240 are configured to execute conversation model 252 to determine, based on the inputted data, one or more words, phrases, and/or words that caller application 208 may convert (e.g., via text-to-speech) to an utterance that caller application 208 may send as part of the conversation to the remote computing device.

In some examples, one or more processors 240 are configured to execute conversation model 252 to generate words, phrases, and sentences in different conversational styles based on user preferences and/or contextual information associated with the call. For example, one or more processors 240 are configured to execute conversation model 252 to determine the conversational style of the conversation in the call, such as by determining, based on the conversation that has already been conducted during the call, whether the conversation style of the conversation is formal or casual, and may generate words, phrases, and sentences according to the determined conversation style. In another example, one or more processors 240 are configured to execute conversation model 252 to generate words, phrases, and sentences in a casual conversation style if conversation model 252 determines that the call is with a personal friend of the user of computing device 202, and to generate words, phrases, and sentences in a formal conversation style if conversation model determines that the call is a business call.

As computing device 102 conducts the conversation with the remote computing device, one or more processors 240 are configured to execute caller application 208 to determine one or more candidate replies that are relevant to the conversation and may output indications of the one or more candidate replies for display at UIC 204 to enable the user of computing device 202 to select a candidate reply. One or more processors 240 are configured to execute caller application 208 to, in response to the user of computing device 202 selecting a candidate reply, generate and send a reply in the conversation that corresponds to the selected candidate reply.

One or more processors 240 are configured to execute caller application 208 to determine one or more candidate replies that are relevant to the conversation. In the case of a conversation, relevant replies to the conversation may be replies that are relevant to replying to the utterance that was most recently received from the remote computing device as part of the conversation and/or replies that are highly likely or probable to be selected by the user to respond to the utterance that was most recently received from the remote computing device as part of the conversation.

Caller application 208 may determine the one or more candidate replies based on contextual information, such as contextual information associated with the call. Such contextual information may include previous utterances in the conversation during the call (e.g., words, phrases, and/or sentences previously spoken by the parties on the call), the vocal characteristics (e.g., intonation) of utterances received from the remote computing device, whether the identity of the remote computing device is listed in the contacts of computing device 202, the location of computing device 202 and/or the remote computing device, the current time and/or date, events listed in an calendar application of computing device 202, previous conversations with the party using the computing device, or any other relevant contextual information.

Caller application 208 may use conversation model 252 to determine one or more candidate replies. For example, one or more processors 240 are configured to execute caller application 208 to, in response to receiving an utterance in the call from the remote computing device, input the contextual information into conversation model 252, and one or more processors 240 are configured to execute conversation model 252 to determine, based on the inputted data, one or more candidate replies that are relevant to the conversation.

One or more processors 240 are configured to execute caller application 208 to output an indication of each of the one or more candidate replies, such as for display at UIC 204, so that a user may interact with UIC 204 to select a candidate reply out of the one or more candidate replies. The user of computing device 202 may provide user input at UIC 204 to select a candidate reply out of the one or more candidate replies displayed by UIC 204, and one or more processors 240 are configured to execute UI module 206 to send an indication of the selected candidate reply. One or more processors 240 are configured to execute caller application 208 to, in response to receiving the indication of the selected candidate reply, send, based at least in part on the selected candidate reply, a reply in the conversation that corresponds to the candidate reply. That is, caller application 208 may generate a reply (e.g., one or more words, phrases, and/or sentences) having the same or similar meaning to the selected candidate reply, and may send, as part of the conversation, a spoken version of the reply to the remote computing device.

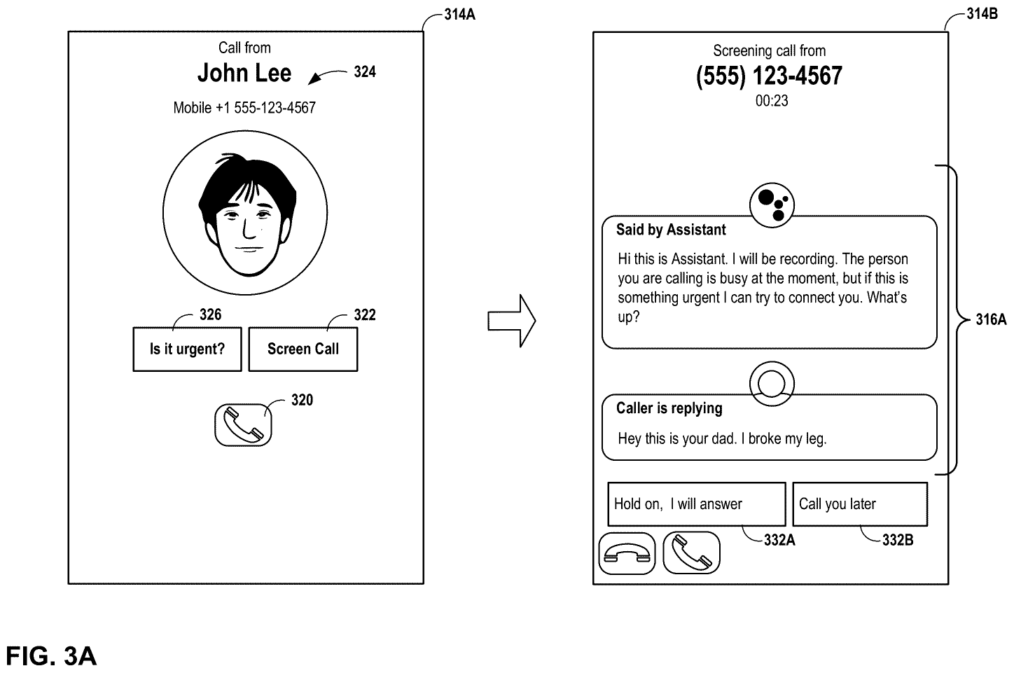

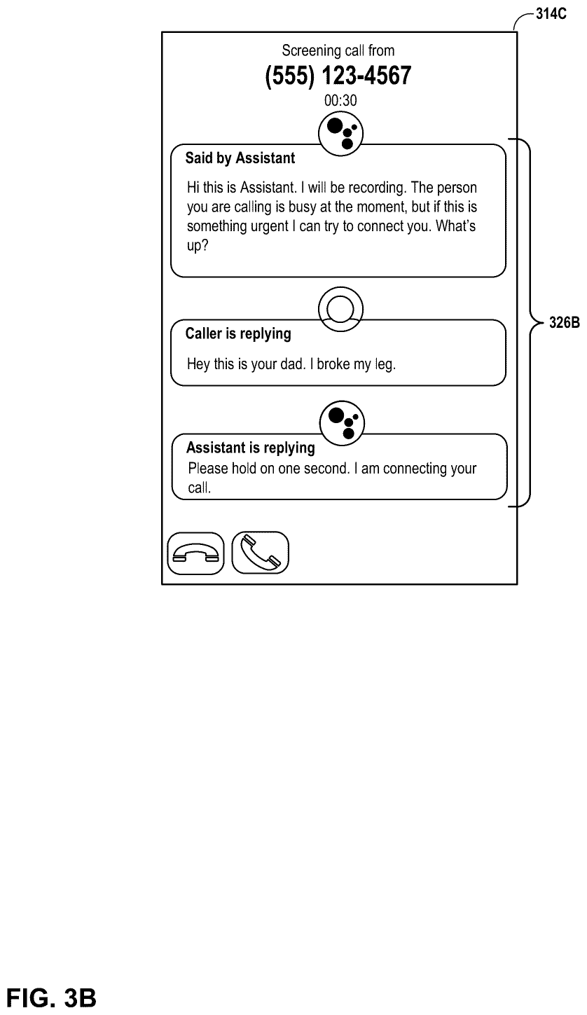

FIGS. 3A and 3B illustrates techniques for call screening of incoming calls, in accordance with aspects of this disclosure. FIGS. 3A and 3B are described with respect to computing device 202 of FIG. 2.

As described above, when computing device 202 receives an incoming call, computing device 202 may perform call screening of an incoming call, which may include conducting a natural language conversation with the calling party to gather certain information from the calling party. As computing device 202 performs the call screening, computing device 202 may determine and output candidate replies that are relevant to the conversation, and the user of computing device 202 may select a candidate reply that may cause computing device 202 to formulate and send a reply in the call that corresponds to the selected candidate reply.

In accordance with aspects of this disclosure, computing device 202 may enable the user of computing device 202 to determine the greeting that computing device 202 may send during the call screening when conducting the natural language conversation with the calling party. Computing device 202 may, in response to receiving an incoming call, determine one or more candidate greetings relevant to the incoming call with which computing device 202 may greet the calling party of the incoming call. Computing device 202 may output an indication of each of the one or more candidate greetings, such for display at UIC 204, and the user of computing device 202 may interact with UIC 204, such as by providing user input at UIC 204, to select a candidate greeting out of the one or more candidate greetings. Computing device 202 may, in response to selection of the candidate greeting, perform call screening of the incoming call that includes sending a greeting that corresponds to the selected candidate greeting as part of the natural language conversation.

Computing device 202 may determine the one or more candidate greetings based on contextual information associated with the incoming call, such as the identity of the calling party (e.g., the phone number of the calling party), whether the calling party is stored in the contacts of computing device 202, the time of day, the location of computing device 202, and the like.

In the example of FIG. 3A, computing device 202 may, in response to receiving an incoming call, execute caller application 208 to send data to UI module 206 that causes UIC 204 to display GUI 314A to alert the user of computing device 202 to the incoming call. For example, UIC 204 may display GUI 314A while ringing (e.g., audibly outputting a ringtone and/or outputting a haptic pattern) to alert the user of computing device 202 to the incoming call.

GUI 314A may include call information 324 associated with the incoming call, such as the phone number from which the incoming call originated, the name of the person or entity associated with the phone number or whether the name of the person or entity associated with the phone number is unknown, and the like. As illustrated in GUI 314A, because the identity (e.g., phone number) of the incoming call is stored in the contacts of computing device 202, computing device 202 may be able to output the name of the caller as part of call information 324 and may also output a picture of the caller in GUI 314A. GUI 314A may include call answering UI element 320 that the user may select (e.g., by providing user input at UIC 204) to answer the call and call screen UI element 322 that user may select (e.g., by providing user input at UIC 204) to cause computing device 202 to perform call screening of the incoming call, as described above with respect to FIGS. 1A and 1B.

In accordance with aspects of this disclosure, computing device 202 may, in response to receiving an incoming call, also determine one or more candidate greetings relevant to the incoming call. Computing device 202 may determine one or more candidate greetings relevant to the incoming call based on the caller type of the calling party (e.g., the person making the incoming call), such as whether the calling party is listed in the contacts of computing device 202, whether the calling party is a business or entity, and the like. For example, computing device 202 may determine, based on information such as the identity of the calling party (e.g., the phone number of the incoming call), the caller type of the calling party, the one or more candidate greetings relevant to the incoming call.

In the example of FIG. 3A, because the identity of the calling party is stored in the contacts of computing device 202, computing device 202 may determine a candidate greeting of “Is it urgent?” that is relevant to the incoming call, and computing device 202 may output an indication of the candidate greeting, such as by including candidate greeting UI element 326 that is labeled “Is it urgent?” in GUI 314A displayed by UIC 204. The user of computing device 202 may provide user input, such as touch input, to interact with UIC 204 to select candidate greeting UI element 326. In response, UI module 206 may send an indication of the user input that corresponds to selection of the candidate greeting that corresponds to UI element 326 to, e.g., caller application 208, and computing device 202 may, in response, start performing call screening of the incoming call, including sending a greeting that corresponds to the selected candidate greeting of “Is this urgent?” as part of the natural language conversation with the calling party.

Computing device 202 may execute caller application 208 to send data to UI module 206 that causes UIC 204 to display GUI 314B, which may be a call screening user interface that includes a real-time transcript 316A of the natural language conversation being conducted by computing device 202 with the calling party as part of the call screening.

Computing device 202 may start off the conversation with the calling party by determining a greeting that corresponds to the selected candidate greeting of “Is this urgent?”. For example, computing device 202 may determine a greeting that is a phrase or a sentence that asks the calling party whether the call is urgent. Computing device 202 may therefore convert the greeting to speech and may send the speech to the calling party as part of the natural language conversation.

As computing device 202 performs call screening and conducts the conversation with the calling party, computing device 202 may also determine one or more candidate replies that are relevant to the call. In the example of FIG. 3A, computing device 202 may receive, as part of the call, an utterance from the calling party of “Hey this is your dad. I broke my leg,” and computing device 202 may, in response, determine one or more candidate replies to the utterance received from the calling party. For example, computing device 202 may determine a candidate reply of “Hold on, I will answer” and a candidate reply of “Call you later” that are relevant to the utterance from the calling party, and may output, in GUI 314B, candidate reply UI element 332A associated with the candidate reply of “Hold on, I will answer” and candidate reply UI element 332B associated with the candidate reply of “Call you later”.

The user of computing device 202 may provide user input, such as touch input, to interact with UIC 204 to select candidate reply UI element 332A associated with the candidate reply of “Hold on, I will answer.” In response, UI module 206 may send an indication of the user input that corresponds to selection of the candidate reply that corresponds to candidate reply UI element 332A to, e.g., caller application 208, and computing device 202 may, in response, formulate and send a reply in the call that corresponds to the selected candidate reply. That is, computing device 202 may determine a reply that is a phrase or a sentence that indicates that the user of computing device 202 will join the call. Computing device 202 may therefore convert the reply corresponding to the selected candidate reply to speech and may send the speech to the calling party as part of the natural language conversation. As shown in FIG. 3B, computing device 202 may execute caller application 208 to send data to UI module 206 that causes UIC 204 to display GUI 314C that includes an updated real-time transcript 316B of the natural language conversation being conducted by computing device 202 that includes the reply of “Please hold on one second. I am connecting your call” corresponding to the selected candidate reply.

Because the intent of the selected candidate reply of “Hold on, I will answer” indicates an intent for the user of computing device 202 to join the call, computing device 202 may also, in response to the user selecting candidate reply UI element 332A associated with the candidate reply of “Hold on, I will answer”, end call screening of the incoming call without disconnecting the call. Instead, computing device 202 may maintain the call and may enable the user of computing device 202 to pick up the call and to start vocally communicating with the calling party via the call (e.g., by speaking to the calling party and to listen to what is said by the calling party).

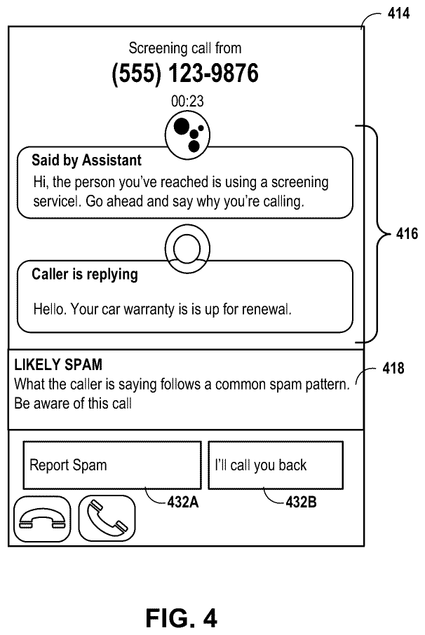

FIG. 4 illustrates additional techniques for call screening, in accordance with aspects of this disclosure. FIG. 4 is described below in the context of computing device 202 of FIG. 2.

As computing device 202 performs call screening of an incoming call and conducts a natural language conversation with the calling party, computing device 202 may be able to determine, based on the conversation being conducted with the calling party, whether the incoming call is a spam call. For example, computing device 202 may determine based on the pattern of utterances received from the calling party, keywords contained within the utterances received from the calling party, or any other relevant contextual information, whether the incoming call is a spam call and/or may determine the likelihood (e.g., probability) that the incoming call is a spam call.

If computing device 202 determines that the incoming call is likely to be a spam call, such as by determining the probability that the incoming call is higher than a probability threshold (e.g., greater than 80% probability, greater than 90% probability, etc.), computing device 202 may output, for display at UIC 204, an indication that the incoming call is likely to be a spam call. Computing device 202 may provide the ability for the user to report the spam call to an external computing system that may add the spam call to a spam example repository that may be used for training and testing spam detection systems.

As shown in FIG. 4, when computing device 202 performs call screening of an incoming call, computing device 202 may execute caller application 208 to send data to UI module 206 that causes UIC 204 to display GUI 414, which may be a call screening user interface that includes a real-time transcript 416 of the natural language conversation being conducted by computing device 202 with the calling party as part of the call screening. Computing device 202 may, in response to detecting that the incoming call is likely to be a spam call, output, in GUI 414, a user interface element 418 indicating the call is likely to be a spam call. Computing device 202 may also include a user interface element 432A that the user may select to cause computing device 202 to report the spam call to an external computing system that may add the spam call to a spam example repository that may be used for training and testing spam detection systems. In some examples, computing device 202 may also output user interface element 432B that the user may select to reply to the calling party that the user will call back the calling party at a later time.

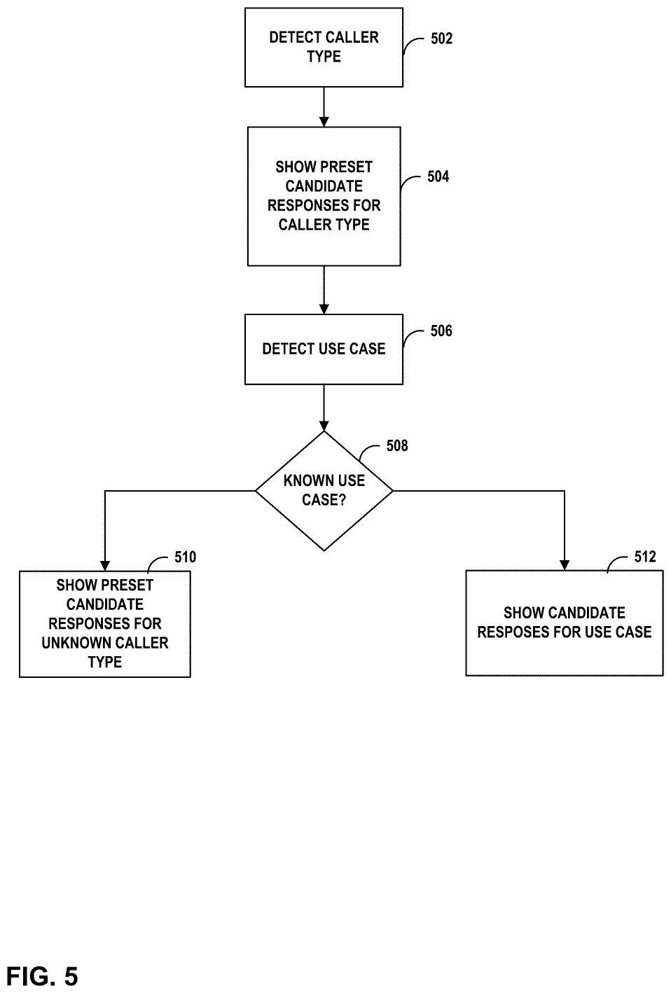

FIG. 5 is a flowchart illustrating an example technique for determining one or more candidate replies, in accordance with aspects of this disclosure. FIG. 5 is described below in the context of computing device 202 of FIG. 2.

As described throughout this disclosure, computing device 202 may perform call screening of incoming calls and may conduct a natural language conversation with the caller of the incoming call. As computing device 202 conducts the natural language conversation, computing device 202 may determine one or more candidate replies that are relevant to the natural language conversation. Computing device 202 may output the set of candidate replies for display at UIC 204. A user may select a candidate reply out of the candidate replies displayed at UIC 204, and computing device 202 may, in response, formulate and send a reply in the call that corresponds to the selected candidate reply.

In the example of FIG. 5, computing device 202 may be able to determine one or more candidate replies that are relevant to the natural language conversation based at least in part on a caller type of the caller (i.e., the party that places the incoming call) and/or the use case of the incoming call. To that end, computing device 202 may, in response to receiving an incoming call, determine the caller type of the caller (502). The caller type may be one of: contact/favorites/work, unknown number, spam, or business. Callers that are a contact/favorites/work caller type, a business type, or a spam type may be referred to as known caller types, while callers that are of an unknown number type may be referred to as unknown caller types.

A caller that is the contact/favorites/work caller type may be a caller having contact details that have already been stored in computing device 202, such as a caller having a phone number that is stored in the contacts of computing device 202. A caller that is a business type may be a caller that computing device 202 determines is from a business (e.g., a store, a doctor's office, etc.) or another entity (e.g., a school, a charity, etc.). Computing device 202 may be able to determine that a caller is a business type by determining that the phone number of the caller is a phone number associated with a business or another entity. A caller that is a spam type may be a caller that computing device 202 determines is placing spam calls. Computing device 202 may be able to determine that a caller is a spam type by determining that the phone number of the caller is a phone number associated with spam calls. If computing device 202 is unable to determine that a caller is a contact/favorites/work caller type, a business type, or a spam type, computing device 202 may determine that the caller is of an unknown number type.

During call screening of a call, computing device 202 may determine a set of candidate replies associated with the caller type of the caller and may output the determined set of candidate replies, such as for display at UIC 204 (504). A user may select a candidate reply, and computing device 202 may formulate and send a reply in the call that corresponds to the selected candidate reply.

If computing device 202 determines that the caller is the contact/favorites/work caller type, computing device 202 may determine the set of candidate replies to be: “Is it urgent?”, “Can you repeat?”, “Tell me more”, “I can't understand”, “Can you text me?”, “I'll text you”, “Be right there”, and “I'll call you back”. If computing device 202 determines that the caller is the business caller type, computing device 202 may determine the set of candidate replies to be: “Report spam”, “Can you repeat?”, “Tell me more”, “I can't understand”, “Can you text me?”, “Who is this?”, “Call back later”, and “Wrong number”. If computing device 202 determines that the caller is the spam caller type, computing device 202 may determine the set of candidate replies to be: “Wrong number” and “Take me off your list”.

If computing device 202 determines that the caller is the unknown number type, computing device 202 may determine the set of candidate replies to be: Report spam”, “Can you repeat?”, “Tell me more”, “I can't understand”, “Who is this?”, “Call back later”, “I'll get back to you”, and “Wrong number”.

As computing device 202 conducts the natural language conversation during the call, computing device 202 may be able to update the caller type of the caller based at least in part on the contextual information associated with the call, such as based on the context of the natural language conversation. For example, computing device 202 may initially determine that the caller is the unknown number type. As computing device 202 performs call screening of the call and conducts a natural language conversation during the call, computing device 202 may determine, based on contextual information such as the contents of the conversation, that the caller is not the unknown number type but is instead a business caller type.

Computing device 202 may therefore update the caller type of the caller and may, in response to updating the caller type of the caller, update the candidate replies for the call to the candidate replies associated with the business caller type. For example, if computing device 202 determines that the caller is not the unknown number type but is instead a business caller type, computing device 202 may update the candidate replies that are outputted at UIC 204 to the candidate replies associated with the business caller type: “Report spam”, “Can you repeat?”, “Tell me more”, “I can't understand”, “Can you text me?”, “Who is this?”, “Call back later”, and “Wrong number”.

In another example, computing device 202 may initially determine that the caller is the unknown number type. As computing device 202 performs call screening of the call and conducts a natural language conversation during the call, computing device 202 may determine, based on contextual information such as the contents of the conversation, that the caller is not the unknown number type but is instead a spam caller type. Computing device 202 may update the caller type of the caller to the spam caller type and may, in response to updating the caller type of the caller, update the candidate replies for the call to the candidate replies associated with the spam caller type. For example, if computing device 202 determines that the caller is not the unknown number type but is instead a spam caller type, computing device 202 may update the candidate replies that are outputted at UIC 204 to be the candidate replies associated with the spam caller type: “Wrong number” and “Take me off your list”.

In addition to determining the caller type of the caller, computing device 202 may also determine the use case of the call (506). A use case of the call may be the purpose of the caller in calling computing device 202. Computing device 202 may determine the use case of the call based on any contextual information related to the call, such as the context of the natural language conversation being conducted, keywords detected in the natural language conversation being conducted, vocal characteristics of the caller, or any other relevant contextual information. In some examples, computing device 202 may input such contextual information related to the call into conversation model 252 to determine the use case of the call.

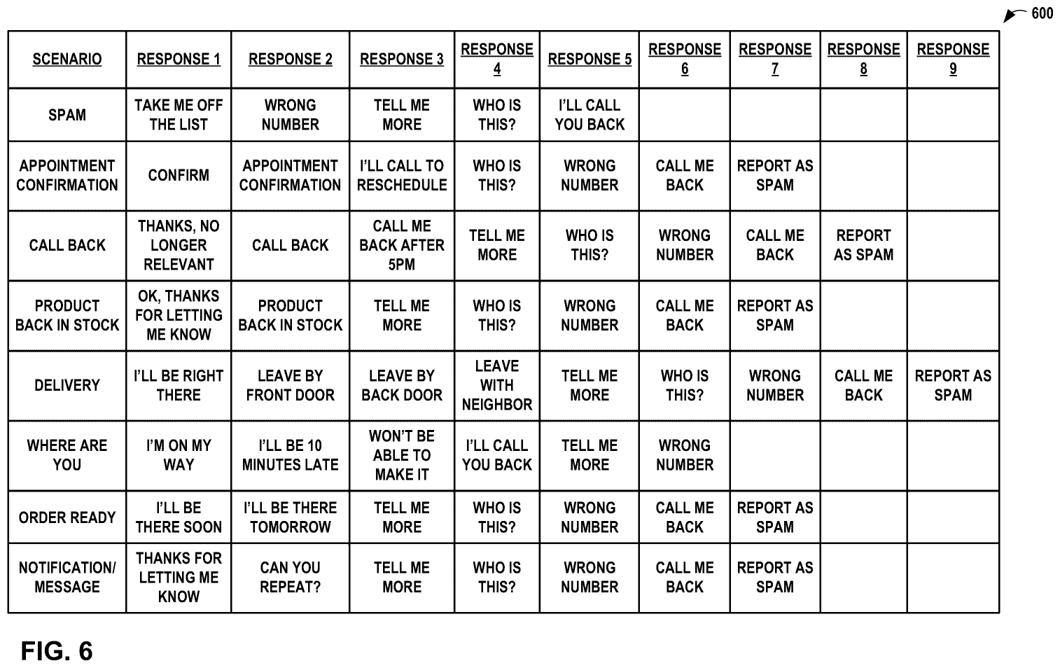

Computing device 202 may determine whether the use case of the call is known, where the use case of the call is unknown if computing device 202 is unable to determine the use case of the call (508). If computing device 202 is unable to determine the use case of the call, computing device 202 may continue to output the set of candidate replies associated with the taller type of the caller (510). If computing device 202 is able to determine the use case of the call, computing device 202 may determine a set of candidate replies associated with the use case of the call, as described in more detail in FIG. 6, and may output the set of candidate replies associated with the use case of the call for display at UIC 204 (512). A user may select a candidate reply, and computing device 202 may formulate and send a reply in the call that corresponds to the selected candidate reply.

In some examples, computing device 202 may determine that the call includes dialpad options, which may include detecting, in the utterances from the calling party, a request to press certain numbers of a dial pad, such as “press 1 to for English”. If computing device 202 determines that the call includes dialpad options, computing device 202 may determine the set of candidate replies to include “report spam” and “wrong number”.

FIG. 6 illustrates example candidate replies associated with use cases of a call, in accordance with aspects of this disclosure. FIG. 6 is described below in the context of computing device 202 of FIG. 2.

As shown in FIG. 6, table 600 illustrates different use cases of a call that may be determined by computing device 202, such as spam, appointment confirmation, call back, product back in stock, delivery, where are you, order ready, and notification/message. A call having a spam use case may be a spam call. A call having an appointment confirmation use case may be a call from a business or other entity to confirm an appointment. A call having a call back use case may be a call from a caller that is calling back the user of computing device 202. A call having a product back in stock use case may be a call from a business or other entity to inform the user of computing device 202 that a product the user is interested in is back in stock. A call having a delivery use case may be a call to inform the user of computing device 202 that an item ordered by the user (e.g., a food order) has arrived. A call having a where are you use case is a call to query the user of computing device 202 regarding the user's location. A call having an order ready use case may be a call from a business or other entity to inform the user of computing device 202 that an item ordered by the user (e.g., a food order) is ready to be picked up. A call having a notification/message use case may be a call to notify the user of computing device 202 of a particular situation and/or a call to deliver a message to the user.

As can be seen in table 600, each use case may be associated with a set of candidate replies. Thus computing device 202 may, in response to determining the use case of a call, determine the set of candidate replies associated with the call and may output indications of the set of candidate replies associated with the call at UIC 204. A user may interact with UIC 204 to select a candidate reply out of the candidate replies associated with the call and computing device 202 may, in response to the user selecting a candidate reply, formulate and send a reply in the call that corresponds to the selected candidate reply.

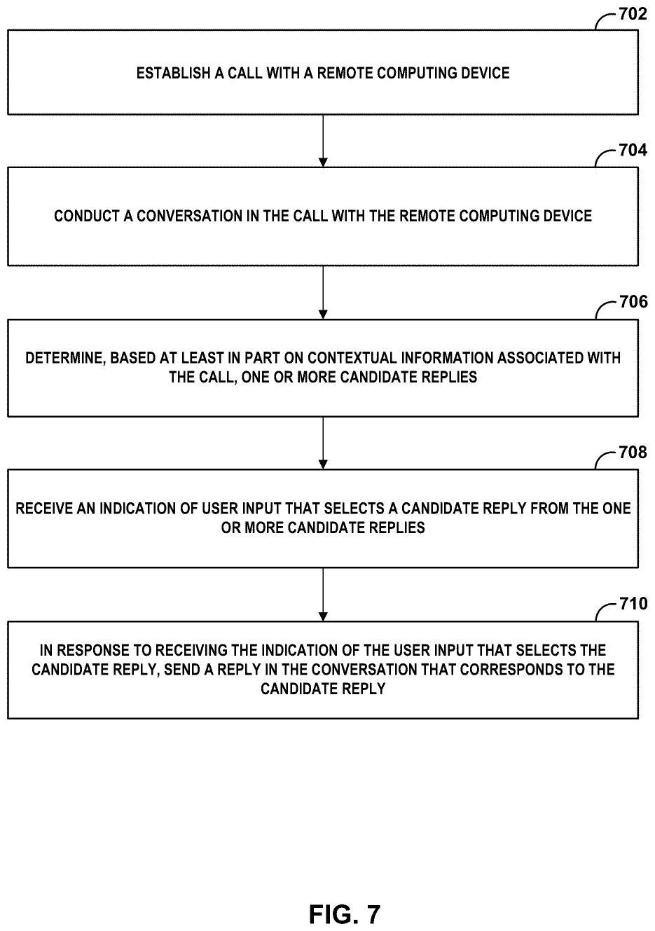

FIG. 7 is a flowchart illustrating example operations performed by an example computing device that is configured to perform call screening, in accordance with one or more aspects of the present disclosure. FIG. 7 is described below in the context of environment 100 of FIG. 1A and computing device 202 of FIG. 2.

As shown in FIG. 7, one or more processors 240 of a computing device 202 may establish a call with a remote computing device 136 (702). One or more processors 240 may conduct a conversation in the call with the remote computing device 136 (704). One or more processors 240 may determine, based at least in part on contextual information associated with the call, one or more candidate replies (706). One or more processors 240 may receive an indication of a user input that selects a candidate reply from the one or more candidate replies (708). One or more processors 240 may, in response to receiving the indication of the user input that selects the candidate reply, send a reply in the conversation that corresponds to the candidate reply (710).

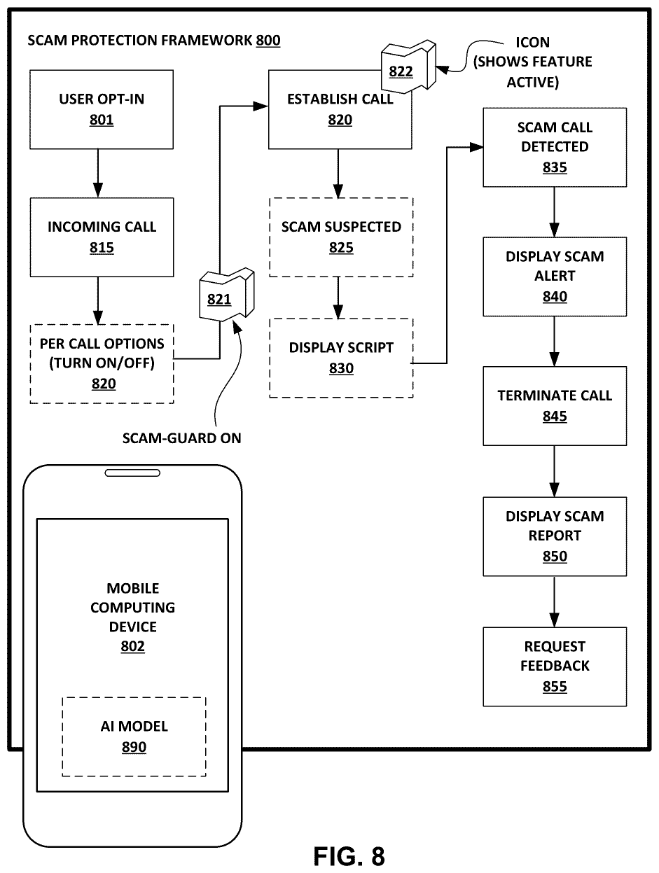

FIG. 8 is a conceptual diagram illustrating scam protection framework 800, in accordance with one or more aspects of the present disclosure. More particularly, as shown in FIG. 8, scam protection framework 800 includes various user interactions, including user opt-in block 801 which provides user privacy protections for mobile computing device 802. For example, scam protection framework 800 may be configured by default to request user permissions or express user authorization prior to analyzing any audio data associated with a phone call, video call, or chat session. Once user opt-in at block 801 is configured on mobile computing device 802 to allow scam protection framework 800 to analyze calls, then when incoming call 815 is received, mobile computing device 802 may establish the call (820) and scam protection framework 800 may begin to analyze the call to determine whether the audio data from the call indicates a scam call.

Optionally, scam protection framework 800 may display options for configuring scam protection framework 800 on a per-call basis. For instance, scam protection framework 800 may display per-call options at block 820 to turn on or turn off scam protection framework 800 for incoming calls (815). In such an example, a setting indicating scam guard on at block 821 may be configured for incoming calls (815) only and mobile computing device 802 may then establish calls (820) with scam protection framework 800 active.

In certain examples, icon 822 shows one or more features of scam protection framework 800 are active for the call. In such examples, icon 822 enables users to readily identify whether the feature is analyzing the call which ensures full transparency to the user.

Privacy protection may be enforced by mobile computing device 802 or AI model 890, or both. For instance, prior to establishing the call between mobile computing device 802 and remote computing device 136, processing circuitry may receive user permission authorizing mobile computing device 802 to analyze the audio data of subsequent calls received by mobile computing device 802. In response to receiving the user permission authorizing mobile computing device 802 to analyze the audio data of calls received by mobile computing device 802, processing circuitry may configure mobile computing device 802 to analyze the audio data of the subsequent calls received by mobile computing device 802.

In some examples, processing circuitry checks each time that a call is received whether or not user consent has been received and whether mobile computing device 802 is configured to analyze data of a call.

In other examples, privacy protections may be enforced by mobile computing device 802 through the use of a non-storage and non-transmitting policy in which audio data from a call and related information are not retained and are not transmitted off-device. For example, AI model 890 may implement an on-device large language model via mobile computing device 802 to process and interpret data associated with a call rather than transmitting the audio data to a remote location. In such examples, AI model 890 may ephemerally evaluate the call data from the call to determine contextual information associated with the call. In such an example, no portion of the call data from the call is retained by mobile computing device 802 or transmitted off of mobile computing device 802 subsequent to ephemerally evaluating the call data from the call. According to such examples, no portion of the contextual information associated with the call is retained by mobile computing device 802 or transmitted off of mobile computing device 802 subsequent to ephemerally evaluating the call data from the call.

In certain cases where a user specifically authorizes AI model 890 to process data off-device (e.g., on a device or system that is distinct from mobile computing device 802), such processing may be performed only after receiving clear and explicit approval by the user to process the audio call data in such a way. For instance, off-device processing may be useful to update or supplement an AI model training dataset for use with initial training or reinforcement training.

In some examples, AI model 890 implements the on-device large language model via mobile computing device 802 to evaluate the call data from the call. For instance, AI model 890 may utilize the on-device large language model to determine the contextual information associated with the call. In some examples, subsequent to terminating the call with remote computing device 136, processing circuitry may send a request for user authorization to transmit the contextual information associated with the call to an off-device cloud computing platform and in response to receipt of the user authorization to transmit the contextual information associated with the call to the off-device cloud computing platform, processing circuitry may transmit the contextual information associated with the call to the off-device cloud computing platform as reinforcement learning training data to update a corresponding source of the on-device large language model at the off-device cloud computing platform. For instance, a cloud provider operating as the source of the on-device large language model may utilize such in-situ training data to improve the source on-device large language model and to create a new and improved variant of the on-device large language model for all users. Processing circuitry of the mobile device may then download the improved AI model 890. For instance, processing circuitry may provision (e.g., download and install) the updated variant of the on-device large language model from the off-device cloud computing platform to mobile computing device 802.

AI model 890 may utilize contextual information associated with a call to perform call analysis. Such contextual information may be derived from metadata associated with the call (e.g., phone number, caller ID, time of day, country code, etc.) or contextual information derived from call data from the call. For instance, in certain examples, while the call is ongoing, processing circuitry of mobile computing device 802 may determine the contextual information associated with the call based at least in part on analyzing the call data from the call. For instance, the contextual information determined in association with the call may include at least one of: spoken words detected within the call data from the call; spoken phrases detected within the call data from the call; caller sentiment detected from sentiment analysis on the call data from the call; callee sentiment detected from the sentiment analysis on the call data from the call; a topic of discussion detected within the call data from the call; and a subject matter category detected within the call data from the call.

In certain examples, natural language processing (NLP) may be utilized to detect sentiment of the callee or the caller from the audio data while the call is ongoing. In at least one example, processing circuitry may implement an on-device natural language processing model via AI model 890. In such an example, analyzing the call data from the call includes performing natural language processing (NLP) on the audio data to determine the contextual information. The natural language processing may include obtaining utterances originating from a callee using the computing device or obtaining utterances originating from a caller using remote computing device 136, or obtaining both. In such an example, processing circuitry may use natural language processing to determine, based at least in part on the utterances, the contextual information associated with the call. In this example, processing circuitry, using AI model 890, may generate a confidence value that the conversation in the call satisfies the scam call threshold based at least in part on the contextual information associated with the call.

In some examples, scam suspected block 825 may optionally be utilized to indicate that scam protection framework 800 suspects a possible scam call, but confidence that the established call (820) meets a scam call threshold has not yet been met. In such a case, scam protection framework 800 may display script 830 with a question for the user to ask the caller. For instance, scam protection framework 800 may display a prompt or question such as “What is the name of the business you are calling from?” Or “Is there a return phone number that I can reach you at?” In such examples, display script 830 may prompt the user of mobile computing device 802 as the callee having received the phone call or video call to read aloud a question from display script 830 to the caller. The display script 830 may elicit additional audio data from the phone call or video call from which scam protection framework 800 may analyze and better determine whether the phone call or video call is a scam call. In other examples, display script 830 may provide a user selectable option to automatically inject text into a chat session to elicit additional call data from the chat session to better determine whether the chat session is a scam interaction.

In some situations, AI model 890 may suspect the call is a scam call, and yet, lack sufficient confidence to satisfy the scam call threshold. In such situations, processing circuitry may configure a suspected scam call threshold having a value lower than the scam call threshold. In this example, prior to terminating the call with remote computing device 136, AI model 890 may determine, based at least in part on the contextual information associated with the call, the call data from the call satisfies the suspected scam call threshold but does not satisfy the scam call threshold. In response the call data from the call satisfies the suspected scam call threshold but does not satisfy the scam call threshold, processing circuitry may send for output by mobile computing device 802, a notification the call with remote computing device 136 the call with remote computing device 136 is a suspected scam call. In such an example, processing circuitry may send for output by mobile computing device 802, a request for a scripted inquiry to be read aloud by a callee during the conversation. Processing circuitry of mobile computing device 802 may monitor, using the on-device large language model, for human language utterances by a callee corresponding to the scripted inquiry within the conversation. In other examples, the on-device large language model monitors for responsive utterances from the caller. In such examples, processing circuitry may increase or decrease a confidence value of the on-device large language model. For instance, processing circuitry may then determine, using the increased or decreased confidence value, whether the call data from the call satisfies the scam call threshold based on the responsive utterances from the caller (e.g., based on the callee reading the script prompted by AI model 890).

In some examples, scam protection framework 800 processes audio data from the call and determines the call is a scam call and initiates scam call detected block 835. Scam protection framework 800 may determine that a call satisfies a scam call threshold or that confidence that the call is a scam call satisfies conditions of scam protection framework 800 indicating a scam call. Responsive to scam call detected 835, scam protection framework 800 may display scam alert 840. For instance, scam protection framework 800 may display another icon or prompt to the user letting them know that scam protection framework 800 has detected a scam call. In some cases, scam protection framework 800 displays options to mobile computing device 802 to dismiss the displayed scam alert or to end the call responsive to the displayed scam alert. For instance, a user may select an option to end the call responsive to the displayed scam alert, responsive to which, scam protection framework 800 may initiate terminate call 845 which ends the call. The user may alternatively select a displayed option to dismiss the alert, in which case the call continues or the user may simply ignore the alert.

AI model 890 may utilize the scam call threshold to determine whether or not sufficient confidence exists to determine the call is a scam call. According to certain examples, AI model 890 implements an on-device natural language processing model or an on-device large language model, or both, via processing circuitry of mobile computing device 802 and uses the on-device natural language processing model to determine whether the call data from the call satisfies the scam call threshold. In such an example, AI model 890 may determine that a call satisfies the scam call threshold when AI model 890 specifies at least one of: the call data from the call with remote computing device 136 is evaluated to include an attempt by a caller to defraud a callee; the call data from the call with remote computing device 136 is evaluated to include illegal statements by the caller to the callee; the call data from the call with remote computing device 136 is evaluated to include an attempt by the caller to extort money from the callee; the call data from the call with remote computing device 136 is evaluated to include an attempt by the caller to disclose authentication information from the callee; the call data from the call with remote computing device 136 is evaluated to include an attempt by the caller to impersonate a governmental entity; the call data from the call with remote computing device 136 is evaluated to include an attempt by the caller to impersonate a law enforcement entity; the call data from the call with remote computing device 136 is evaluated to include an attempt by the caller to impersonate technical support agency; the call data from the call with remote computing device 136 is evaluated to include an attempt by the caller to impersonate a bank associated with the callee; and the call data from the call with remote computing device 136 is evaluated to include an attempt by the caller to impersonate an e-commerce platform customer support representative.

In examples where terminate call 845 ends a call at mobile computing device 802, scam protection framework 800 may initiate display scam report 850. For instance, such a feature may inform the user why the call was a suspected scam call, such as due to a threatening tone from the caller or a request for money by the caller, and so forth.

In certain examples, scam protection framework 800 will request feedback 855 from the user. For instance, if the user dismisses a scam alert, request feedback 855 may ask the user why the user elected to continue the call. For instance, the call may be legitimate and scam call detected 835 may have been erroneous. Request feedback 855 may gather relevant information which may be provided back into an AI model 890 to improve its performance going forward for mobile computing device 802. In some examples, request feedback 855 may activate after terminate call block 845 activates responsive to detection of a scam call to solicit information from the user regarding the accuracy of the detection.

Feedback may be helpful to improve the predictive accuracy of AI model 890 through the use of reinforcement learning. In one example, processing circuitry of mobile computing device 802 executes an on-device large language model at mobile computing device 802 within AI model 890. In such an example subsequent to terminating the call with remote computing device 136, processing circuitry may request user feedback 855 about the call with remote computing device 136. In response to requesting user feedback 855 about the call with remote computing device 136, processing circuitry may obtain user feedback 855 and input user feedback 855 about the call with remote computing device 136 to the on-device large language model. In such an example, AI model 890 may update the on-device large language model using at least user feedback 855 as reinforcement learning training data for the on-device large language model.

Scam protection framework 800 may execute locally on a mobile computing device 802. For instance, processing circuitry may execute an application or functionality to implement scam protection framework 800. According to at least one example, scam protection framework 800 executes within a user-provisionable application or “app” on a mobile computing device 802 such as a smartphone. In other examples, scam protection framework 800 executes via a default app or a manufacturer installed application which may be updated and configured. In certain examples, scam protection framework 800 executes as a priority application with privileged access to operating system functions and APIs. In some examples, scam protection framework 800 operates at an operating system level rather than an application level.

According to at least one example, scam protection framework 800 detects scam calls by analyzing the contents of a phone conversation. For instance, based on analysis of the contents of the call, as represented within call data from the call, scam protection framework 800 may determine that a call is a scam call and alert a user's mobile computing device 802. For instance, scam protection framework 800 may cause haptic feedback to buzz the user's phone or display a warning on the screen, or both.

Scam protection framework 800 may utilize various output modes and initiate alerts to the user in different combinations based on a confidence value AI model 890 generated, which indicates whether the call is a scam call. According to one example, processing circuitry of mobile computing device 802 causes the alert to be output by mobile computing device 802. Example alerts may include an audible alert, a graphical alert, a haptic alert or any combination thereof.

In some examples, processing circuitry causes the alert to be output by a device associated with or communicably linked to mobile computing device 802 rather than or in addition to being output by mobile computing device 802. For instance, processing circuitry may cause the alert to be output by a smart watch associated with mobile computing device 802, augmented reality wearable glasses associated with mobile computing device 802, artificial intelligence wearable glasses associated with mobile computing device 802, to a remote component separate from mobile computing device 802, headphones audibly interfaced with mobile computing device 802, a smart speaker audibly associated with mobile computing device 802, or any combination thereof.

In certain examples, processing circuitry sends the alert indicating the call with remote computing device 136 is the scam call by transmitting the alert using one or more communication channels. For instance, processing circuitry may inject into a communication channel and for audible output by mobile computing device 802, the alert within the conversation on an output channel detectable by the callee and undetectable by the caller. In another example, processing circuitry sends, for display by mobile computing device 802, the alert to a display screen of mobile computing device 802. In certain examples, processing circuitry sends, for display, the alert to a display interface of a smart watch associated with mobile computing device 802. In other examples, processing circuitry sends, for display, the alert to a display interface of an augmented reality wearable glasses computing device associated with mobile computing device 802. In one example, processing circuitry sends, for display, the alert to a display interface of an artificial intelligence wearable glasses computing device associated with mobile computing device 802. In another example processing circuitry sends, for display, the alert to a display interface of a remote component having a separate display than mobile computing device 802. In at least one example, processing circuitry sends, for display, the alert to a display interface of an emergency contact computing device associated with mobile computing device 802. In some examples, processing circuitry sends, for output, the alert to an audio user interface associated with mobile computing device 802. In one example, processing circuitry sends the alert to a speaker of mobile computing device 802. In another example, processing circuitry sends for output, the alert to headphones audibly interfaced with mobile computing device 802.

Processing circuitry of mobile computing device 802 may be configured to send an alert to a trusted contact or an emergency contact of the callee based on the conditions observed during the call. In at least one example, prior to terminating the call with remote computing device 136, processing circuitry may send a message to an emergency contact computing device configured within mobile computing device 802. In such an example, the message to the emergency contact computing device indicates at least: the callee of mobile computing device 802 is participating in the call with remote computing device 136 and the call with remote computing device 136 is determined to be the scam call. Consider for instance a person responsible for an elderly parent and configured as the trusted or emergency contact within the elderly parent's smart phone. In such a scenario, AI model 890 could send the scam call alert to the emergency contact, letting them know in real time while the call is ongoing, that their elderly parent may be communicating with a potential scammer and is at risk. Such an alert may prompt a trusted or emergency contact to reach out to the user of mobile computing device 802 and potentially avert a scam.

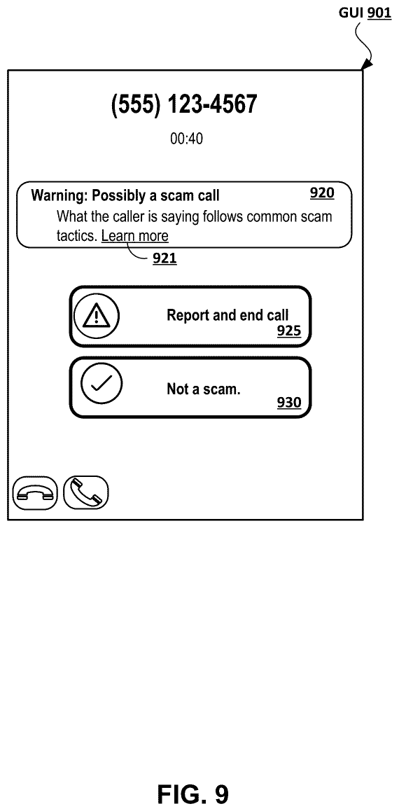

FIG. 9 is a conceptual diagram illustrating an example GUI 901 that includes user selectable options 925 and 930 responsive to scam call alert 920, in accordance with one or more aspects of the present disclosure. For purposes of illustration, GUI 901 is described within the context of scam protection framework 800 and mobile computing device 802 of FIG. 8.

As illustrated in FIG. 9, scam protection framework 800 is active and mobile computing device 802 outputs GUI 901, including scam call alert 920 indicating that the call is possibly a scam call. Scam call alert may indicate the reason for displaying the scam call alert 920, such as indicating that the statements made by the caller follow common scam tactics. In certain examples, GUI 901 may include “learn more” link 921 to provide the user an easy way to get additional coaching or guidance. For instance, subsequent to terminating the call with remote computing device 136, processing circuitry may send for output by the computing device, a message linking to content with coaching about understanding and identifying telephone calls, video calls, and chat sessions from scammers or other malicious actors.

User selectable option 925 enables the user to report the call as a scam and terminate the call. Conversely, user selectable option 930 enables the user to dismiss scam call alert 920, indicating the call is not a scam. Such user interactions may be provided to an on-device AI model 890 to further improve the prediction accuracy of AI model 890 for the user when using scam protection framework 800.

In some examples, scam call alert 920 may warn the user in conjunction with an explanation that the user is at risk of talking to a scammer and offer options to close the call and report a given call as a scam. For instance, user selectable option 925 enables the user to report the scam call while user selectable option 930 enables the user to dismiss scam call alert 920 and proceed with the call.

In situations where a user dismisses scam call alert 920 and continues with the call, AI model 890 may continue to evaluate call data from the call in an attempt to detect whether the call is a scam call, notwithstanding the user dismissal of scam call alert 920. In such examples, subsequent to obtaining the initial user input dismissing scam call alert 920, processing circuitry may determine, using the ongoing call data from the call and based at least in part on contextual information associated with the call, whether the call satisfies a secondary scam call threshold. Responsive to determining that the call satisfies the secondary scam call threshold, processing circuitry may send, for output by mobile computing device 802, a second alert indicating the call with remote computing device 136 is the scam call. Stated differently, this would be a second warning and scam alert presented to the user during the same call. In such an example, subsequent to sending the second alert indicating the call with remote computing device 136 is the scam call, processing circuitry may receive user input requesting to end the call. For example, the user may choose to end the call after the second scam call alert despite dismissing the first alert. In such an example, processing circuitry then terminates the call with remote computing device 136.

A user of mobile computing device 802 may ignore a scam alert entirely or possibly does not see, hear, or feel the scam alert. In such cases, a second alert may be initiated. For instance, consider where the scam call threshold is a first scam call threshold having a value lower than a secondary scam threshold.

AI model 890 may continue to evaluate the ongoing call to determine if call data from the call satisfies the higher second scam call threshold, at which point, another alert may be initiated, notwithstanding the first alert being ignored. For example, prior to terminating the call with remote computing device 136, processing circuitry may determine whether there is an absence of any user interaction with the alert indicating the call with remote computing device 136 is the scam call. Responsive to determining that there is an absence of any user interaction with the alert indicating the call with remote computing device 136 is the scam call, processing circuitry may continue evaluating the call data from the call with remote computing device 136 without terminating the call with remote computing device 136. For example, because the scam call alert was ignored, processing circuitry does not terminate the call. Subsequent to determining the absence of any user interaction with the alert indicating the call with remote computing device 136 is the scam call, processing circuitry may determine, based at least in part on contextual information associated with the call, whether the call satisfies a secondary scam call threshold. Responsive to determining that the call satisfies the secondary scam call threshold, processing circuitry may initiate a second alert indicating the call with remote computing device 136 is the scam call. Based on that second scam call alert and in response to receiving the user input to end the call based on the second alert, processing circuitry may terminate the call with remote computing device 136.

In other situations, AI model 890 may establish a sufficiently high level of confidence that a call is a scam call, that scam protection framework 800 takes automatic action. For instance, when confidence in a scam call reaches a critical scam call threshold, processing circuitry may terminate the call without user input and then output an explanation of why the call was terminated. In at least one example, the scam call threshold is a first scam call threshold and a critical scam call threshold has a higher level than the first scam call threshold. In this example, processing circuitry may automatically terminate the call with remote computing device 136 when the call data from the call satisfies the critical scam call threshold in the absence of the user input with the indication of the request to end the call. In such an example, processing circuitry sends for output by mobile computing device 802, a notification indicating one or more reasons for terminating the call with remote computing device 136.

Previous solutions cannot identify a scam call without a user first speaking with the potential scammer. The problem is made worse by scammers rotating and/or spoofing their phone numbers, which is common practice. Further still, previous solutions offer no mechanism to definitively establish that a given phone number is certainly spoofed. Due to such practices, crowdsourcing, though helpful, is insufficient to identify scam calls based on the originating phone number. With previously known techniques, there is no mechanism by which to reliably identify that a call is a scam.

The call screening assistant described in relation to FIGS. 3A-3B, 4, 5, 6, and 7 is helpful to filtering spam calls and nuisance calls, however, a scammer can defeat the screening assistant simply by misrepresenting their identity or purpose. Therefore, use of AI model 890 to analyze the audio data while mobile computing device 802 enables a stronger level of protection from malicious actors seeking to scam the user.

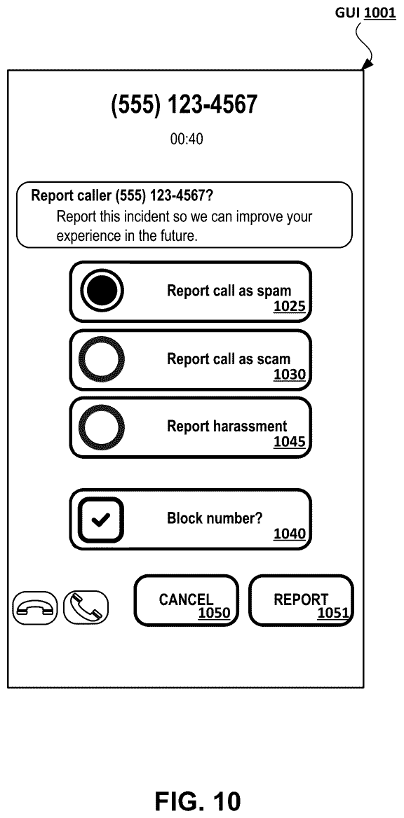

FIG. 10 is a conceptual diagram illustrating an example GUI 1001 that includes various user selectable options based on a determination by a scam protection framework that a call is a scam call, in accordance with one or more aspects of the present disclosure. For purposes of illustration, GUI 1001 is described within the context of scam protection framework 800 and mobile computing device 802 of FIG. 8.

In examples where a user decided to end the incoming call and report it as a scam call (e.g., by selecting user selection option 925), mobile computing device 802 outputs GUI 1001 from which a user may select various options for reporting the scam call. According to some examples, GUI 1001 includes user selectable options to categorize the type of call. For instance, report call as spam 1025 option is selected within GUI 1001 and indicates that while not a scam call, the call may nevertheless be a spam or nuisance call. Report call as scam 1030 is another user selectable option which is depicted as unselected, but if chosen, will classify the call as a scam call.

In some examples, GUI 1001 includes a user selectable option to report harassment 1045, shown here as unselected. If chosen, report harassment 1045 will classify the call as harassment which may be helpful for calls which although not a scam or a spam call, are nevertheless unwanted by the user due to, for instance, bullying, hate speech, and so forth.

In at least one example, GUI 1001 includes a selected by default block number 1040 option. The user may unselect this option or leave it selected, in which case, the number will be blocked for the user's mobile computing device going forward, regardless of the type of report submitted.

Responsive to selecting report 1051, the indication that the incoming call was a scam call may be provided to on-device AI model 890 to improve future predictive performance. Selecting report 1051 may optionally cause a report to be provided to a third-party cloud provider to improve predictive performance of future upgrades of the on-device AI model 890 for all users by crowd-sourcing data across a large number of users. If the user selects cancel 1050, then no action will be taken.

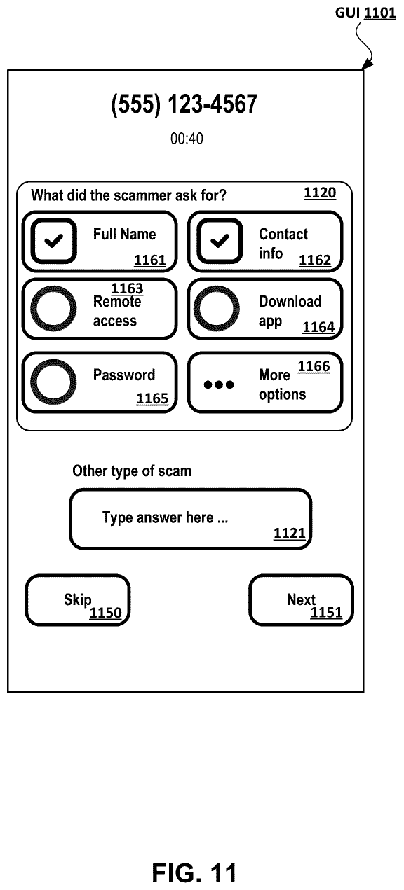

FIG. 11 is a conceptual diagram illustrating an example GUI 1101 that includes various user selectable options to provide feedback based on a determination by a scam protection framework that a call is a scam call, in accordance with one or more aspects of the present disclosure. For purposes of illustration, GUI 1101 is described within the context of scam protection framework 800 and mobile computing device 802 of FIG. 8.

In some examples, mobile computing device 802 may display GUI 1101, including scam assessment 1120, to the user asking the user what kind of scam was attempted. Scam assessment 1220 may include user selectable options via which the user may provide feedback to scam protection framework 800 and AI model 890. For example, the user may indicate that the scammer asked for the user's full name 1161, contact information 1162, remote access 1163 to the user's mobile computing device or to another computing device associated with the user. Scam assessment 1120 may include questions asking if the scammer requested the user indicate whether the scammer asked for the user to download app 1164, provide password 1165, or if the option is not available, then user may enter information into the input box 1121 to type an answer for another type of scam. Users may optionally select more options 1166 to have scam protection framework 800 provide more selectable options and categories. Users may submit the feedback on the scam assessment 1120 screen by selecting next 1151 or the user may skip 1150 providing such information.

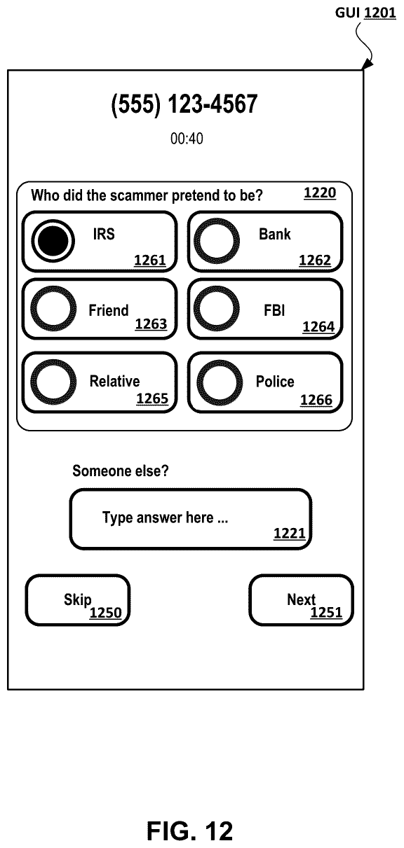

FIG. 12 is a conceptual diagram illustrating an example GUI 1201 that includes various user selectable options to provide feedback based on a determination by a scam protection framework that a call is a scam call, in accordance with one or more aspects of the present disclosure. For purposes of illustration, GUI 1201 is described within the context of scam protection framework 800 and mobile computing device 802 of FIG. 8.

In some examples, mobile computing device 802 may display GUI 1201, including scam assessment 1220, to the user asking the user who the scammer was impersonating. For example, scam assessment 1220 may include user selectable options via which the user may provide feedback to scam protection framework 800 and AI model 890. For example, the user may indicate that the scammer was impersonating IRS 1261, impersonating bank 1262, impersonating friend 1263, impersonating FBI 1264, impersonating relative 1265, or impersonating police 1266. In some examples, the relevant option may not be displayed, in which case, the user may enter information into the input box 1221 to type an answer identifying another person or entity impersonated by the scammer. Users may select next 1251 to submit feedback provided in scam assessment 1220 or skip 1250 if the user does not wish to submit information.

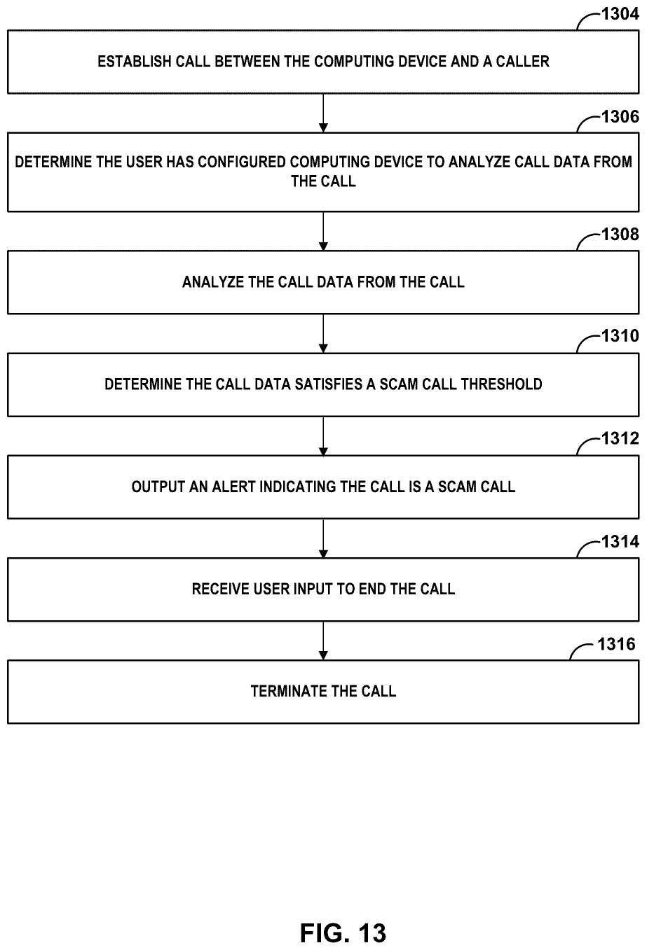

FIG. 13 is a flowchart illustrating example operations performed by an example computing device that is configured to detect and alert for scam calls, in accordance with one or more aspects of the present disclosure. FIG. 13 is described below in the context of environment 100 of FIG. 1A and computing device 202 of FIG. 2.

As shown in FIG. 13, one or more processors 240 may establish a call between computing device 202 and a caller (1304). For example, the one or more processors 240 of computing device 202 may establish a call between the computing device 202 and a caller. In some examples, a call is established responsive to the computing device receiving a call from the caller. In other examples, a call is established when the computing device places an outgoing call to the caller.

One or more processors 240 may determine the user has configured computing device 202 to analyze call data from the call (1306). For example, the one or more processors 240 of computing device 202 may determine whether a user of the computing device 202 configured the computing device 202 to analyze call data from the call.

While the call is ongoing, one or more processors 240 may analyze call data from the call (1308). For example, responsive to determining that the user configured the computing device 202 to analyze the call data from the call, the one or more processors 240 of computing device 202 may analyze the call data from the call.

One or more processors 240 may determine the call data satisfies a scam call threshold (1310). For example, the one or more processors 240 of computing device 202 may determine, based at least in part on contextual information associated with the call, whether the call satisfies a scam call threshold.

One or more processors 240 may output an alert indicating the call is a scam call (1312). For example, in response to determining that the call satisfies the scam call threshold, output an alert indicating the call with the caller is a scam call.

One or more processors 240 may receive user input to end the call (1314) and terminate the call (1316). For example, responsive to receiving user input to end the call, the one or more processors 240 of computing device 202 may terminate the call with caller.

This disclosure includes the following examples.

Example 1: A method comprising: establishing, by one or more processors of a computing device, a call between the computing device and a caller; determining, by the one or more processors of the computing device, whether a user of the computing device configured the computing device to analyze call data from the call; responsive to determining that the user configured the computing device to analyze the call data from the call: while the call is ongoing, analyzing, by the one or more processors of the computing device, the call data from the call; determining, by the one or more processors of the computing device and based at least in part on contextual information associated with the call, whether the call satisfies a scam call threshold; and responsive to determining that the call satisfies the scam call threshold, outputting, by the one or more processors, an alert indicating the call with the caller is a scam call; and responsive to receiving user input to end the call, terminating, by the one or more processors, the call with the caller.

Example 2. The method of example 1, further comprising: prior to establishing the call between the mobile computing device and the remote computing device, receiving, by the one or more processors, user permission authorizing the mobile computing device to analyze the audio data of subsequent calls received by the mobile computing device; and responsive to receiving the user permission authorizing the mobile computing device to analyze the audio data of calls received by the mobile computing device, configuring, by the one or more processors, the mobile computing device to analyze the audio data of the subsequent calls received by the mobile computing device.

Example 3. The method of any of examples 1 or 2, further comprising: while the call is ongoing, determining, by the one or more processors of the mobile computing device, the contextual information associated with the call based at least in part on analyzing the call data from the call; wherein the contextual information determined in association with the call includes at least one of: spoken words detected within the call data from the call; spoken phrases detected within the call data from the call; caller sentiment detected from sentiment analysis on the call data from the call; callee sentiment detected from the sentiment analysis on the call data from the call; a topic of discussion detected within the call data from the call; and a subject matter category detected within the call data from the call.

Example 4. The method of any of examples 1-3, further comprising: executing, by the one or more processors, an on-device large language model via the mobile computing device; executing, by the one or more processors, an on-device large language model; evaluating, by the one or more processors and using the on-device large language model, the data of the call to determine the contextual information; and wherein evaluating the data of the call to determine the contextual information comprises evaluating at least one of: audio data exchanged between the caller and the computing device during a phone call; the audio data, video data, image data, chat data, file attachments, or some combination thereof exchanged between the caller and the computing device during a video call; and the audio data, the video data, the image data, the chat data, the file attachments, or some combination thereof exchanged between the caller and the computing device during a chat session.

Example 5. The method of any of examples 1-4, further comprising: executing, by the one or more processors, an on-device large language model at the mobile computing device; subsequent to terminating the call with the remote computing device, requesting, by the one or more processors, user feedback about the call with the remote computing device; in response to requesting the user feedback about the call with the remote computing device, obtaining, by the one or more processors, the user feedback; inputting, by the one or more processors, the user feedback about the call with the remote computing device to the on-device large language model; and updating, by the one or more processors, the on-device large language model using at least the user feedback as reinforcement learning training data for the on-device large language model.

Example 6. The method of any of examples 1-5, further comprising: executing, by the one or more processors, an on-device large language model via the mobile computing device; evaluating, by the one or more processors using the on-device large language model, the call data from the call to determine the contextual information associated with the call; subsequent to terminating the call with the remote computing device, sending, by the one or more processors and for display to the mobile computing device, a request for user authorization to transmit the contextual information associated with the call to an off-device cloud computing platform; in response to receiving the user authorization to transmit the contextual information associated with the call to the off-device cloud computing platform, transmitting, by the one or more processors, the contextual information associated with the call to the off-device cloud computing platform as reinforcement learning training data to update the on-device large language model; and provisioning, by the one or more processors, an updated variant of the on-device large language model from the off-device cloud computing platform to the mobile computing device.

Example 7. The method of any of examples 1-7, further comprising: executing, by the one or more processors, an on-device natural language processing model via the mobile computing device; increasing, by the one or more processors using the on-device natural language processing model, a confidence value of the on-device natural language processing model that the call data from the call satisfies the scam call threshold based on one or more matching conditions detected by the on-device natural language processing model, wherein the one or more matching conditions include one or more of: a key-word match between one or more words of a key-word list and any human language utterances within the conversation detected by the on-device natural language processing model; a phrase match with one or more phrases of a phrase list and any of the human language utterances detected within the conversation by the on-device natural language processing model; a caller sentiment match between one or more sentiment classifications on a sentiment watch list and a sentiment assessment by the on-device natural language processing model based on the conversation; and a subject matter match between one or more subject matter categories on a subject matter watch list and a subject matter categorization assessed by the on-device natural language processing model based on the conversation.

Example 8. The method of any of examples 1-7, further comprising: executing, by the one or more processors, an on-device natural language processing model via the mobile computing device; determining, by the one or more processors using the on-device large language model, the call data from the call satisfies the scam call threshold when the on-device large language model specifies at least one of: the call data from the call with the remote computing device is evaluated to include an attempt by a caller to defraud a callee; the call data from the call with the remote computing device is evaluated to include illegal statements by the caller to the callee; the call data from the call with the remote computing device is evaluated to include an attempt by the caller to extort money from the callee; the call data from the call with the remote computing device is evaluated to include an attempt by the caller to disclose authentication information from the callee; the call data from the call with the remote computing device is evaluated to include an attempt by the caller to impersonate a governmental entity; the call data from the call with the remote computing device is evaluated to include an attempt by the caller to impersonate a law enforcement entity; the call data from the call with the remote computing device is evaluated to include an attempt by the caller to impersonate technical support agency; the call data from the call with the remote computing device is evaluated to include an attempt by the caller to impersonate a bank associated with the callee; and the call data from the call with the remote computing device is evaluated to include an attempt by the caller to impersonate an e-commerce platform customer support representative.

Example 9. The method of any of examples 1-8, further comprising: prior to terminating the call with the remote computing device, obtaining, by the one or more processors, initial user input dismissing the alert indicating the call with the remote computing device is the scam call; in response to obtaining the initial user input dismissing the alert indicating the call with the remote computing device is the scam call, continue evaluating, by the one or more processors, the call data from the call with the remote computing device without terminating the call with the remote computing device; subsequent to obtaining the initial user input dismissing the alert indicating the call with the remote computing device is the scam call, determining, by the one or more processors of the mobile computing device and based at least in part on contextual information associated with the call, whether the call satisfies a secondary scam call threshold; in response to determining the call satisfies the secondary scam call threshold, sending, by the one or more processors and for output by the mobile computing device, a second alert indicating the call with the remote computing device is the scam call; and subsequent to sending the second alert indicating the call with the remote computing device is the scam call and responsive to receiving the user input to end the call, terminating, by the one or more processors, the call with the remote computing device.

Example 10. The method of any of examples 1-9, further comprising: prior to terminating the call with the remote computing device, sending, by the one or more processors, a message to an emergency contact computing device configured within the mobile computing device; and wherein the message to the emergency contact computing device indicates at least: the callee of the mobile computing device is participating in the call with the remote computing device; and the call with the remote computing device is determined to be the scam call.

Example 11. The method of any of examples 1-10, further comprising: executing, by the one or more processors, an on-device large language model via the mobile computing device; increasing, by the one or more processors using the on-device large language model, a confidence value of the on-device large language model that the call data from the call satisfies the scam call threshold based on one or more conditions detected within the call data from the call, wherein the one or more conditions include one or more of: a caller requests a one time password number; a callee begins reading the one time password number during the conversation; the caller requests remote control access to a different computing device associated with a callee; the call with the remote computing device is assessed by the on-device large language model as being initiated by a robo-dialer; the call with the remote computing device is assessed by the on-device large language model as originating from a robo-caller; the call with the remote computing device is assessed by the on-device large language model as corresponding to a spoofed telephone number; the call with the remote computing device is assessed by the on-device large language model as beginning with a pre-recorded message or a computer-generated spoken language message; the call with the remote computing device is assessed by the on-device large language model as including a generic greeting lacking information specific to the callee; the caller indicates the callee should not terminate the call; the caller indicates the callee has been chosen for a discount or a prize; the caller makes one or more statements or utterances assessed by the on-device large language model as including a threat to the callee; the caller makes one or more statements or utterances assessed by the on-device large language model as including a threatening tone; the caller makes one or more statements or utterances assessed by the on-device large language model as including an urgent tone; the caller makes one or more statements assessed by the on-device large language model as including high-pressure sales tactics; the caller makes one or more statements assessed by the on-device large language model as including a limited time offer to the callee; the caller declines a request to answer questions by the callee requesting at least one of: what business entity the caller represents, a return telephone number for the caller, or follow up details about an offer presented by the caller; the caller requests the callee to confirm personal information; the caller requests a payment utilizing a financial payment instrument other than a credit card; and the caller requests a credit card payment to cover shipping and handling.

Example 12. The method of any of examples 1-11, wherein the scam call threshold is a first scam call threshold having a value lower than a secondary scam threshold, the method further comprising: prior to terminating the call with the remote computing device, determining, by the one or more processors, an absence of any user interaction with the alert indicating the call with the remote computing device is the scam call; in response to determining the absence of any user interaction with the alert indicating the call with the remote computing device is the scam call, continue evaluating, by the one or more processors, the call data from the call with the remote computing device without terminating the call with the remote computing device; subsequent to determining the absence of any user interaction with the alert indicating the call with the remote computing device is the scam call, determining, by the one or more processors of the mobile computing device and based at least in part on contextual information associated with the call, whether the call satisfies a secondary scam call threshold; in response to determining the call satisfies the secondary scam call threshold, sending, by the one or more processors and for output by the mobile computing device, a second alert indicating the call with the remote computing device is the scam call; and subsequent to sending the second alert indicating the call with the remote computing device is the scam call and responsive to receiving the user input to end the call, terminating, by the one or more processors, the call with the remote computing device.

Example 13. The method of any of examples 1-12, further comprising: subsequent to terminating the call with the remote computing device, sending, by the one or more processors and for output by the computing device, a message linking to content with coaching about understanding and identifying telephone calls, video calls, and chat sessions from scammers or other malicious actors.

Example 14. The method of any of examples 1-13, wherein the scam call threshold is a first scam call threshold; wherein a critical scam call threshold has a higher level than the first scam call threshold; wherein the method further comprises: automatically terminating, by the one or more processors, the call with the remote computing device when the call data from the call satisfies the critical scam call threshold in the absence of the user input with the indication of the request to end the call; and sending, by the one or more processors and for output by the mobile computing device, a notification indicating one or more reasons for terminating the call with the remote computing device.

Example 15. The method of any of examples 1-14, further comprising: sending, by the one or more processors and for output by the mobile computing device, concurrent with sending the alert indicating the call with the remote computing device is the scam call, at least two user-selectable options, including: a first user-selectable option to dismiss the alert without terminating the call with the remote computing device; and a second user-selectable option to terminate the call with the remote computing device.

Example 16. The method of any of examples 1-15, further comprising: executing, by the one or more processors, an on-device large language model via the mobile computing device; configuring, by the one or more processors, a suspected scam call threshold having a value lower than the scam call threshold; prior to terminating the call with the remote computing device, determining, by the one or more processors and based at least in part on the contextual information associated with the call, the call data from the call satisfies the suspected scam call threshold but does not satisfy the scam call threshold; responsive to determining the call data from the call satisfies the suspected scam call threshold but does not satisfy the scam call threshold, sending, by the one or more processors and for output by the mobile computing device, a notification the call with the remote computing device the call with the remote computing device is a suspected scam call; sending, by the one or more processors and for output by the mobile computing device, a request for a scripted inquiry to be read aloud by a callee during the conversation; monitoring, by the one or more processors and using the on-device large language model, for human language utterances by a callee corresponding to the scripted inquiry within the conversation; monitoring, by the one or more processors and using the on-device large language model, for responsive utterances from the caller; and increasing or decreasing a confidence value of the on-device large language model that the call data from the call satisfies the scam call threshold based on the responsive utterances from the caller.

Example 17. The method of any of examples 1-16, further comprising: sending, by the one or more processors and for output by the mobile computing device, the alert indicating the call with the remote computing device is the scam call by transmitting the alert using one or more communication channels, including: injecting, by the one or more processors and for audible output by the mobile computing device, the alert within the conversation on an output channel detectable by the callee and undetectable by the caller; sending, by the one or more processors and for display by the mobile computing device, the alert to a display screen of the mobile computing device; sending, by the one or more processors and for display, the alert to a display interface of a smart watch associated with the mobile computing device; sending, by the one or more processors and for display, the alert to a display interface of an augmented reality wearable glasses computing device associated with the mobile computing device; sending, by the one or more processors and for display, the alert to a display interface of an artificial intelligence wearable glasses computing device associated with the mobile computing device; sending, by the one or more processors and for display, the alert to a display interface of a remote component having a separate display than the mobile computing device; sending, by the one or more processors and for display, the alert to a display interface of an emergency contact computing device associated with the mobile computing device; sending, by the one or more processors and for output, the alert to an audio user interface associated with the mobile computing device; sending, by the one or more processors and for output, the alert to a speaker of the mobile computing device; and sending, by the one or more processors and for output, the alert to headphones audibly interfaced with the mobile computing device.

Example 18. The method of any of examples 1-17, further comprising: sending, by the one or more processors and for output by the mobile computing device, the alert indicating the call with the remote computing device is the scam call by transmitting an audible tone or a haptic feedback alert or both the audible tone and the haptic feedback alert to at least one of: the mobile computing device; a smart watch associated with the mobile computing device; augmented reality wearable glasses associated with the mobile computing device; artificial intelligence wearable glasses associated with the mobile computing device; a remote component separate from the mobile computing device; headphones audibly interfaced with the mobile computing device; and a smart speaker audibly associated with the mobile computing device.

Example 19. A mobile computing device comprising: one or more processors; and non-transitory computer readable media that stores instructions, wherein the instructions, when executed by the one or more processors, configure the one or more processors to: in response to receipt of an incoming call from a remote computing device, establish, by one or more processors of a mobile computing device, a call between the mobile computing device and the remote computing device; determine, by the one or more processors of the mobile computing device, whether a user of the mobile computing device configured the mobile computing device to analyze call data from the call; responsive to a determination that the user configured the mobile computing device to analyze the call data from the call: while the call is ongoing, analyze, by the one or more processors of the mobile computing device, the call data from the call; determine, by the one or more processors of the mobile computing device and based at least in part on contextual information associated with the call, whether the call satisfies a scam call threshold; and responsive to a determination that the call satisfies the scam call threshold, output, by the one or more processors, an alert to indicate the call with the remote computing device is a scam call; and responsive to receipt of user input to end the call, terminate, by the one or more processors, the call with the remote computing device.

Example 20. The mobile computing device of example 19, wherein the instructions, when executed by the one or more processors, further configure the one or more processors to: prior to establishment of the call between the mobile computing device and the remote computing device, receive, by the one or more processors, user permission authorizing the mobile computing device to analyze the audio data of subsequent calls received by the mobile computing device; and responsive to receipt of the user permission authorizing the mobile computing device to analyze the audio data of calls received by the mobile computing device, configure, by the one or more processors, the mobile computing device to analyze the audio data of the subsequent calls received by the mobile computing device.

Example 21. The mobile computing device of example 19 or 20, wherein the instructions, when executed by the one or more processors, further configure the one or more processors to: while the call is ongoing, determine, by the one or more processors of the mobile computing device, the contextual information associated with the call based at least in part on analysis the call data from the call; wherein the contextual information determined in association with the call includes at least one of: spoken words detected within the call data from the call; spoken phrases detected within the call data from the call; caller sentiment detected from sentiment analysis on the call data from the call; callee sentiment detected from the sentiment analysis on the call data from the call; a topic of discussion detected within the call data from the call; and a subject matter category detected within the call data from the call.

Example 22. The mobile computing device of any of examples 19-21, wherein the instructions, when executed by the one or more processors, further configure the one or more processors to: execute, by the one or more processors, an on-device large language model via the mobile computing device; ephemerally evaluate, by the one or more processors using the on-device large language model, the call data from the call to determine the contextual information, wherein no portion of the call data from the call is retained by the mobile computing device or transmitted off of the mobile computing device subsequent to the ephemeral evaluation the call data from the call, and further wherein no portion of the contextual information associated with the call is retained by the mobile computing device or transmitted off of the mobile computing device subsequent to the ephemeral evaluation the call data from the call.

Example 23. The mobile computing device of any of examples 19-22, wherein the instructions, when executed by the one or more processors, further configure the one or more processors to: execute, by the one or more processors, an on-device large language model at the mobile computing device; subsequent to termination of the call with the remote computing device, request, by the one or more processors, user feedback about the call with the remote computing device; responsive to the request for the user feedback about the call with the remote computing device, obtain, by the one or more processors, the user feedback; input, by the one or more processors, the user feedback about the call with the remote computing device to the on-device large language model; and update, by the one or more processors, the on-device large language model using at least the user feedback as reinforcement learning training data for the on-device large language model.

Example 24. Non-transitory computer-readable storage media comprising instructions that, when executed, configure processing circuitry of a mobile computing device to: in response to receipt of an incoming call from a remote computing device, establish a call between the mobile computing device and the remote computing device; determine whether a user of the mobile computing device configured the mobile computing device to analyze call data from the call; responsive to a determination that the user configured the mobile computing device to analyze the call data from the call: while the call is ongoing, analyze the call data from the call; determine, based at least in part on contextual information associated with the call, whether the call satisfies a scam call threshold; and responsive to a determination that the call satisfies the scam call threshold, output an alert to indicate the call with the remote computing device is a scam call; and responsive to receipt of user input to end the call, terminate the call with the remote computing device.

Example 25. The non-transitory computer-readable storage media of example 24, wherein the instructions, when executed, further configure the processing circuitry of the mobile computing device to: prior to establishment of the call between the mobile computing device and the remote computing device, receive user permission authorizing the mobile computing device to analyze the audio data of subsequent calls received by the mobile computing device; and responsive to receipt of the user permission authorizing the mobile computing device to analyze the audio data of calls received by the mobile computing device, configure the mobile computing device to analyze the audio data of the subsequent calls received by the mobile computing device.

Example 26. The non-transitory computer-readable storage media of examples 24 or 25, wherein the instructions, when executed, further configure the processing circuitry of the mobile computing device to: while the call is ongoing, determine the contextual information associated with the call based at least in part on analysis of the call data from the call; wherein the contextual information determined in association with the call includes at least one of: spoken words detected within the call data from the call; spoken phrases detected within the call data from the call; caller sentiment detected from sentiment analysis on the call data from the call; callee sentiment detected from the sentiment analysis on the call data from the call; a topic of discussion detected within the call data from the call; and a subject matter category detected within the call data from the call.

Example 27. The non-transitory computer-readable storage media of examples 24-26, wherein the instructions, when executed, further configure the processing circuitry of the mobile computing device to: execute an on-device large language model via the mobile computing device; ephemerally evaluate using the on-device large language model, the call data from the call to determine the contextual information, wherein no portion of the call data from the call is retained by the mobile computing device or transmitted off of the mobile computing device subsequent to the ephemeral evaluation the call data from the call, and further wherein no portion of the contextual information associated with the call is retained by the mobile computing device or transmitted off of the mobile computing device subsequent to the ephemeral evaluation the call data from the call.

Example 28. The non-transitory computer-readable storage media of examples 24-27, when executed, further configure the processing circuitry of the mobile computing device to: execute, by the one or more processors, an on-device large language model at the mobile computing device; subsequent to termination of the call with the remote computing device, request, by the one or more processors, user feedback about the call with the remote computing device; responsive to the request for the user feedback about the call with the remote computing device, obtain, by the one or more processors, the user feedback; input, by the one or more processors, the user feedback about the call with the remote computing device to the on-device large language model; and update, by the one or more processors, the on-device large language model using at least the user feedback as reinforcement learning training data for the on-device large language model.

By way of example, and not limitation, such computer-readable storage media can comprise RAM, ROM, EEPROM, CD-ROM or other optical disk storage, magnetic disk storage, or other magnetic storage devices, flash memory, or any other storage medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage mediums and media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of a computer-readable medium.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structures suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of inter-operative hardware units, including one or more processors as described above, in conjunction with suitable software and/or firmware.

Various embodiments have been described. These and other embodiments are within the scope of the following claims.

What is claimed is:

1. A method comprising:
establishing, by one or more processors of a computing device, a call between the computing device and a caller;
determining, by the one or more processors of the computing device, whether a user of the computing device configured the computing device to analyze call data from the call;
responsive to determining that the user configured the computing device to analyze the call data from the call:
while the call is ongoing, analyzing, by the one or more processors of the computing device, the call data from the call;
determining, by the one or more processors of the computing device and based at least in part on contextual information associated with the call, whether the call satisfies a scam call threshold; and
responsive to determining that the call satisfies the scam call threshold, outputting, by the one or more processors, an alert indicating the call with the caller is a scam call; and
responsive to receiving user input to end the call, terminating, by the one or more processors, the call with the caller.

2. The method of claim 1, further comprising:
prior to establishing the call between the computing device and the caller, receiving, by the one or more processors, user permission authorizing the computing device to analyze the call data of subsequent calls received by the computing device; and
responsive to receiving the user permission authorizing the computing device to analyze the call data of calls received by the computing device, configuring, by the one or more processors, the computing device to analyze the call data of the subsequent calls received by the computing device.

3. The method of claim 1, further comprising:
while the call is ongoing, determining, by the one or more processors of the computing device, the contextual information associated with the call based at least in part on analyzing the call data from the call;
wherein the contextual information determined in association with the call includes at least one of:
spoken words detected within the call data from the call;
spoken phrases detected within the call data from the call;
caller sentiment detected from sentiment analysis on the call data from the call;
callee sentiment detected from the sentiment analysis on the call data from the call;
a topic of discussion detected within the call data from the call; and
a subject matter category detected within the call data from the call.

4. The method of claim 1, further comprising:
executing, by the one or more processors, an on-device large language model;
evaluating, by the one or more processors and using the on-device large language model, the call data of the call to determine the contextual information; and
wherein evaluating the call data of the call to determine the contextual information comprises evaluating at least one of:
audio data exchanged between the caller and the computing device during a phone call;
the audio data, video data, image data, chat data, file attachments, or some combination thereof exchanged between the caller and the computing device during a video call; and
the audio data, the video data, the image data, the chat data, the file attachments, or some combination thereof exchanged between the caller and the computing device during a chat session.

5. The method of claim 1, further comprising:
subsequent to terminating the call with the caller, requesting, by the one or more processors, user feedback about the call with the caller;
in response to requesting the user feedback about the call with the caller, obtaining, by the one or more processors, the user feedback; and
updating, by the one or more processors, an on-device AI model using the user feedback about the call with the caller.

6. The method of claim 1, further comprising:
executing, by the one or more processors, an on-device large language model via the computing device;
evaluating, by the one or more processors using the on-device large language model, the call data from the call to determine the contextual information associated with the call;
responsive to determining that the user authorized transmission of the contextual information associated with the call to an off-device cloud computing platform, transmitting, by the one or more processors, the contextual information associated with the call to the off-device cloud computing platform as reinforcement learning training data to update the on-device large language model; and
provisioning, by the one or more processors, an updated variant of the on-device large language model from the off-device cloud computing platform to the computing device.

7. The method of claim 1, further comprising:
executing, by the one or more processors, an on-device natural language processing model via the computing device;
increasing, by the one or more processors and using the on-device natural language processing model, a confidence value indicative of the call data from the call satisfying the scam call threshold based on one or more matching conditions detected by the on-device natural language processing model, wherein the one or more matching conditions include one or more of:
a keyword match between one or more words of a keyword list and any human language utterances within the call data detected by the on-device natural language processing model;
a phrase match with one or more phrases of a phrase list and any of the human language utterances detected within the call data by the on-device natural language processing model;
a caller sentiment match between one or more sentiment classifications on a sentiment watch list and a sentiment assessment by the on-device natural language processing model based on the call data; and
a subject matter match between one or more subject matter categories on a subject matter watch list and a subject matter categorization assessed by the on-device natural language processing model based on the call data.

8. The method of claim 1, further comprising:
executing, by the one or more processors, an on-device natural language processing model via the computing device;
determining, by the one or more processors using the on-device natural language processing model, the call data from the call satisfies the scam call threshold when the on-device natural language processing model specifies at least one of:
the call data from the call with the caller is evaluated to include an attempt by a caller to defraud a callee;
the call data from the call with the caller is evaluated to include illegal statements by the caller to the callee;
the call data from the call with the caller is evaluated to include an attempt by the caller to extort money from the callee;
the call data from the call with the caller is evaluated to include an attempt by the caller to disclose authentication information from the callee;
the call data from the call with the caller is evaluated to include an attempt by the caller to impersonate a governmental entity;
the call data from the call with the caller is evaluated to include an attempt by the caller to impersonate a law enforcement entity;
the call data from the call with the caller is evaluated to include an attempt by the caller to impersonate technical support agency;
the call data from the call with the caller is evaluated to include an attempt by the caller to impersonate a bank associated with the callee; and
the call data from the call with the caller is evaluated to include an attempt by the caller to impersonate an e-commerce platform customer support representative.

9. The method of claim 1, further comprising:
prior to terminating the call with the caller, obtaining, by the one or more processors, initial user input dismissing the alert indicating the call with the caller is the scam call;
subsequent to obtaining the initial user input, determining, by the one or more processors of the computing device and based at least in part on additional audio data received after obtaining the initial user input, whether the call satisfies a secondary scam call threshold;
responsive to determining the call satisfies the secondary scam call threshold, outputting, by the one or more processors, a second alert indicating the call with the caller is the scam call; and
subsequent to sending the second alert indicating the call with the caller is the scam call and responsive to receiving the user input to end the call, terminating, by the one or more processors, the call with the caller.

10. The method of claim 1, further comprising:
prior to terminating the call with the caller, sending, by the one or more processors, a message to an emergency contact configured within the computing device; and
wherein the message to the emergency contact computing device indicates at least:
a callee of the computing device is participating in the call with the caller; and
the call with the caller is determined to be the scam call.

11. A computing device comprising:
one or more processors; and
non-transitory computer readable media that stores instructions, wherein the instructions, when executed by the one or more processors, configure the one or more processors to:
establish, by one or more processors of a computing device, a call between the computing device and a caller;
determine, by the one or more processors of the computing device, whether a user of the computing device configured the computing device to analyze call data from the call;
responsive to a determination that the user configured the computing device to analyze the call data from the call:
while the call is ongoing, analyze, by the one or more processors of the computing device, the call data from the call;
determine, by the one or more processors of the computing device and based at least in part on contextual information associated with the call, whether the call satisfies a scam call threshold; and
responsive to a determination that the call satisfies the scam call threshold, output, by the one or more processors, an alert to indicate the call with the caller is a scam call; and
responsive to receipt of user input to end the call, terminate, by the one or more processors, the call with the caller.

12. The computing device of claim 11, wherein the instructions, when executed by the one or more processors, further configure the one or more processors to:
prior to establishment of the call between the computing device and the caller, receive, by the one or more processors, user permission authorizing the computing device to analyze the call data of subsequent calls received by the computing device; and
responsive to receipt of the user permission authorizing the computing device to analyze the call data of calls received by the computing device, configure, by the one or more processors, the computing device to analyze the call data of the subsequent calls received by the computing device.

13. The computing device of claim 11, wherein the instructions, when executed by the one or more processors, further configure the one or more processors to:
while the call is ongoing, determine, by the one or more processors of the computing device, the contextual information associated with the call based at least in part on analysis the call data from the call;
wherein the contextual information determined in association with the call includes at least one of:
spoken words detected within the call data from the call;
spoken phrases detected within the call data from the call;
caller sentiment detected from sentiment analysis on the call data from the call;
callee sentiment detected from the sentiment analysis on the call data from the call
a topic of discussion detected within the call data from the call; and
a subject matter category detected within the call data from the call.

14. The computing device of claim 11, wherein the instructions, when executed by the one or more processors, further configure the one or more processors to:
execute, by the one or more processors, an on-device large language model via the computing device; and
evaluate, by the one or more processors and using the on-device large language model, the data of the call to determine the contextual information; and
wherein evaluation of the data of the call to determine the contextual information comprises the one or more processors to evaluate at least one of:
audio data exchanged between the caller and the computing device during a phone call;
the audio data, video data, image data, chat data, file attachments, or some combination thereof exchanged between the caller and the computing device during a video call; and
the audio data, the video data, the image data, the chat data, the file attachments, or some combination thereof exchanged between the caller and the computing device during a chat session.

15. The computing device of claim 11, wherein the instructions, when executed by the one or more processors, further configure the one or more processors to:
execute, by the one or more processors, an on-device large language model at the computing device;
subsequent to termination of the call with the caller, request, by the one or more processors, user feedback about the call with the caller;
responsive to the request for the user feedback about the call with the caller, obtain, by the one or more processors, the user feedback;
input, by the one or more processors, the user feedback about the call with the caller to the on-device large language model; and
update, by the one or more processors, the on-device large language model using at least the user feedback as reinforcement learning training data for the on-device large language model.

16. Non-transitory computer-readable storage media comprising instructions that, when executed, configure processing circuitry of a computing device to:
establish a call between the computing device and a caller;
determine whether a user of the computing device configured the computing device to analyze call data from the call;
responsive to a determination that the user configured the computing device to analyze the call data from the call:
while the call is ongoing, analyze the call data from the call;
determine, based at least in part on contextual information associated with the call, whether the call satisfies a scam call threshold; and
responsive to a determination that the call satisfies the scam call threshold, output an alert to indicate the call with the caller is a scam call; and
responsive to receipt of user input to end the call, terminate the call with the caller.

17. The non-transitory computer-readable storage media of claim 16, wherein the instructions, when executed, further configure the processing circuitry of the computing device to:
prior to establishment of the call between the computing device and the caller, receive user permission authorizing the computing device to analyze the call data of subsequent calls received by the computing device; and
responsive to receipt of the user permission authorizing the computing device to analyze the call data of calls received by the computing device, configure the computing device to analyze the call data of the subsequent calls received by the computing device.

18. The non-transitory computer-readable storage media of claim 16, wherein the instructions, when executed, further configure the processing circuitry of the computing device to:
while the call is ongoing, determine the contextual information associated with the call based at least in part on analysis of the call data from the call;
wherein the contextual information determined in association with the call includes at least one of:
spoken words detected within the call data from the call;
spoken phrases detected within the call data from the call;
caller sentiment detected from sentiment analysis on the call data from the call;
callee sentiment detected from the sentiment analysis on the call data from the call;
a topic of discussion detected within the call data from the call; and
a subject matter category detected within the call data from the call.

19. The non-transitory computer-readable storage media of claim 16, wherein the instructions, when executed, further configure the processing circuitry of the computing device to:
execute an on-device large language model via the computing device; and
evaluate, by the processing circuitry and using the on-device large language model, the data of the call to determine the contextual information; and
wherein the processing circuitry being configured to evaluate of the data of the call to determine the contextual information comprises the processing circuitry being configured to evaluate at least one of:
audio data exchanged between the caller and the computing device during a phone call;
the audio data, video data, image data, chat data, file attachments, or some combination thereof exchanged between the caller and the computing device during a video call; and
the audio data, the video data, the image data, the chat data, the file attachments, or some combination thereof exchanged between the caller and the computing device during a chat session.

20. The non-transitory computer-readable storage media of claim 16, wherein the instructions, when executed, further configure the processing circuitry of the computing device to:
execute an on-device large language model at the computing device;
subsequent to termination of the call with the caller, request user feedback about the call with the caller;
responsive to the request for the user feedback about the call with the caller, obtain the user feedback;
input the user feedback about the call with the caller to the on-device large language model; and
update the on-device large language model using at least the user feedback as reinforcement learning training data for the on-device large language model.
